(19) United States
(12) Patent Application Publication
(10) Pub. No.: US 2026/0010211 A1
(43) Pub. Date: Jan. 8, 2026

(54) FOLDABLE ELECTRONIC DEVICE INCLUDING SHAPE MEMORY ALLOY

(71) Applicant: SAMSUNG ELECTRONICS CO., LTD., Suwon-si (KR)

(72) Inventors: Jaehyoung YOU, Suwon-si (KR); Jaedeok LIM, Suwon-si (KR); Gyuyeong CHO, Suwon-si (KR)

(21) Appl. No.: 19/185,038

(22) Filed: Apr. 21, 2025

Related U.S. Application Data
(63) Continuation of application No. PCT/KR2025/004936, filed on Apr. 11, 2025.

(30) Foreign Application Priority Data
Jul. 3, 2024 (KR) 10-2024-0087753
Jul. 25, 2024 (KR) 10-2024-0098732

(51) Int. Cl. G06F 1/16; H01F 7/04

(52) U.S. Cl. CPC G06F 1/1679; G06F 1/1652; G06F 1/1681; H01F 7/04

(57) ABSTRACT

An electronic device includes a hinge structure, first and second housings, and a first magnetic module disposed at the first housing and including at least one magnetic body accommodated in a first magnetic body housing to which a wire driving unit is coupled so that the first magnetic body housing is movable, a feeding unit seated on the wire driving unit, a first elastic member coupled to the first magnetic body housing and to the wire driving unit, and a wire coupled to the feeding unit and to the first magnetic body housing. The wire includes a shape memory alloy and is deformable. The first elastic member is deformable in a direction opposite to a deformation direction of the wire. The feeding unit includes a second elastic member configured to be coupled to the wire to be deformed in the same direction as the deformation direction.

### CROSS-REFERENCE TO RELATED APPLICATIONS

This application is a continuation application, claiming priority under §365(c), of International Application No. PCT/KR2025/004936, filed on April 11, 2025, which is based on and claims the benefit of Korean patent application number 10-2024-0098732 filed on July 25, 2024, in the Korean Intellectual Property Office and of Korean patent application number 10-2024-0087753, filed on July 03, 2024, in the Korean Intellectual Property Office, the disclosures of which are incorporated by reference herein in their entireties..

### TECHNICAL FIELD

Embodiments disclosed herein relate to a foldable electronic device including a shape memory alloy.

### BACKGROUND

Foldable electronic devices (e.g., laptop computers, foldable smartphones) capable of being folded and unfolded use physical fastening structures and/or the magnetic force of magnets to maintain a folded (or closed) state. In the folded state, a user may unfold the foldable electronic device by removing the fastening force of the physical fastening structure (e.g., a button) of two housings that fold toward each other and/or the attractive force between magnets disposed in the two housings. During this process, the user has to perform an operation for applying a certain level or higher of external force to the foldable electronic device, and when the operation is repeated every time the device is unfolded, the convenience of the user and the usability of the product may deteriorate. In order to easily implement the unfolding motion of the foldable electronic device, a method of moving magnets so that the attractive force between the magnets is reduced may be considered.

The aforementioned information may be provided as the related art to aid in understanding the present disclosure. No claim or determination is made as to whether any of the above matters constitutes the related art regarding to the present disclosure.

### SUMMARY

An aspect of the present disclosure is to provide an electronic device including a hinge structure, a first housing connected to the hinge structure, a second housing coupled to the hinge structure to be foldable with respect to the first housing around the hinge structure as a center, a display at least a portion of which is disposed at the first housing and the second housing, and a first magnetic module disposed at the first housing, in which the first magnetic module includes at least one magnetic body arranged in a first direction, a first magnetic body housing accommodating the at least one magnetic body, a wire driving unit at least a portion of which is connected to the first housing and at least partially coupled to the first magnetic body housing so that the first magnetic body housing is movable with respect to the first housing, a feeding unit seated on one side of the wire driving unit, a first elastic member with one end in the first direction coupled to the first magnetic body housing and the other end coupled to the wire driving unit, and a wire with one end in the first direction coupled to the feeding unit and the other end coupled to the first magnetic body housing, the wire includes a shape memory alloy so that a length in the first direction is deformable as current is supplied from the feeding unit, the first elastic member is configured to be deformed in a direction opposite to a deformation direction of the wire, and the feeding unit includes a substrate electrically connected to the wire and a second elastic member at least a portion of which is disposed at the substrate and configured to be coupled to the one end of the wire to be deformed in the same direction as the deformation direction of the wire.

Another aspect of the present disclosure is to provide a foldable electronic device including a hinge structure, a first housing connected to the hinge structure, a second housing coupled to the hinge structure to be foldable with respect to the first housing around the hinge structure as a center, a display at least a portion of which is disposed at the first housing and the second housing, and a first magnetic module disposed at an inner edge of the first housing located below the display, in which the first magnetic module includes at least one magnetic body arranged in a first direction, a first magnetic body housing accommodating the at least one magnetic body, a wire driving unit at least a portion of which is connected to the first housing and at least partially coupled to the first magnetic body housing so that the first magnetic body housing is movable with respect to the first housing, a feeding unit seated on one side of the wire driving unit, a first elastic member with one end in the first direction coupled to the first magnetic body housing and the other end coupled to the wire driving unit, and a wire with one end in the first direction coupled to the feeding unit and the other end coupled to the first magnetic body housing, the wire includes a shape memory alloy so that a length in the first direction is deformable as current is supplied from the feeding unit, the first elastic member is configured to be deformed in a direction opposite to a deformation direction of the wire, and at least a portion adjacent to the one end of the wire that is coupled to the feeding unit is formed to be elastically deformed in a direction corresponding to a length change of the wire in the first direction.

### BRIEF DESCRIPTION OF THE DRAWINGS

FIG. 1A is a front perspective view of an electronic device according to an embodiment.

FIG. 1B is a plan view illustrating a rear surface of an electronic device according to an embodiment.

FIG. 2 is a partial exploded perspective view of an electronic device of FIGS. 1A and 1B including a hinge according to an embodiment.

FIG. 3 are perspective views illustrating a process of unfolding an electronic device from a folded state according to an embodiment.

FIG. 4 are perspective views illustrating an example of shapes of a first magnetic module and a second magnetic module according to an embodiment.

FIG. 5 is a perspective view illustrating a shape of the first magnetic module in FIG. 4 as viewed from a different angle.

FIG. 6 is an exploded perspective view of the first magnetic module of the electronic device according to an embodiment.

FIG. 7 are perspective views illustrating a portion of a coupled structure of a first magnetic module according to an embodiment.

FIG. are perspective views illustrating another portion of the coupled structure of the first magnetic module according to an embodiment.

FIG. 9 are perspective and top-down views illustrating a wire relaxed state of the first magnetic module including the wire according to an embodiment.

FIG. 10 are perspective and top-down views illustrating a wire contracted state of the first magnetic module including the wire according to an embodiment.

FIG. 11 are perspective and side views illustrating an example of a coupled structure of the wire and a feeding unit according to an embodiment.

FIG. 12 are perspective, side and top-down views illustrating an example of a shape of a substrate of a feeding unit as viewed from various angles according to an embodiment.

FIG. 13 is a perspective view illustrating an example of a shape of a second elastic member according to an embodiment.

FIG. 14 are views illustrating a shape of the second elastic member in FIG. 13 as viewed from various angles.

FIG. 15 are side views illustrating an example of a form in which a wire and an elastic member are deformed according to an embodiment.

FIG. 16 are perspective and side views illustrating an example of a coupled structure of a wire and a feeding unit according to an embodiment.

FIG. 17 is a side view illustrating an example of a coupled structure of a wire and a feeding unit according to an embodiment.

FIG. 18 are perspective and side views illustrating an example of a coupled structure of a wire and a feeding unit according to an embodiment.

FIG. 19 is a perspective view illustrating an example of a form in which a first magnetic module and a second magnetic module are applied to an electronic device according to an embodiment.

FIG. 20 are perspective views illustrating an example of a form in which a first magnetic module and a second magnetic module according to an embodiment are applied to an electronic device.

FIG. 21 illustrates a block diagram of an exemplary electronic device 2100 capable of performing the operations described herein.

### DETAILED DESCRIPTION

Hereinafter, various embodiments disclosed in the present disclosure will be described with reference to the accompanying drawings. However, this is not intended to limit the present disclosure to the specific embodiments, and it is to be construed to include various modifications, equivalents, and/or alternatives of embodiments of the present disclosure.

Embodiments disclosed herein relate to embodiments in which modules including magnets are respectively disposed in two housings of a foldable electronic device, and at least one magnetic module (e.g., a first magnetic module) of the two modules includes a shape memory alloy wire. The shape memory alloy wire may have a length that may be changed depending on the supply of current, and accordingly, a magnet connected to the wire and the first magnetic module including the magnet may be moved in one direction. By moving the first magnetic module, a magnetic force (or attractive force) acting between the two magnetic modules may be reduced, and the foldable electronic device may be changed from a folded state to an unfolded state. By adjusting the movement of the first magnetic module, an easy unfolding motion of the foldable electronic device may be implemented without direct manipulation by a user (e.g., manipulation of widening a gap between two housings). In addition, by moving the first magnetic module through a change in the length of the shape memory alloy wire, power consumption may be reduced and miniaturization of the magnetic module may be achieved compared to when using a separate actuator (e.g., a motor). The “movement” of the first magnetic module may refer to a case where some component included in the first magnetic module moves relative to other components.

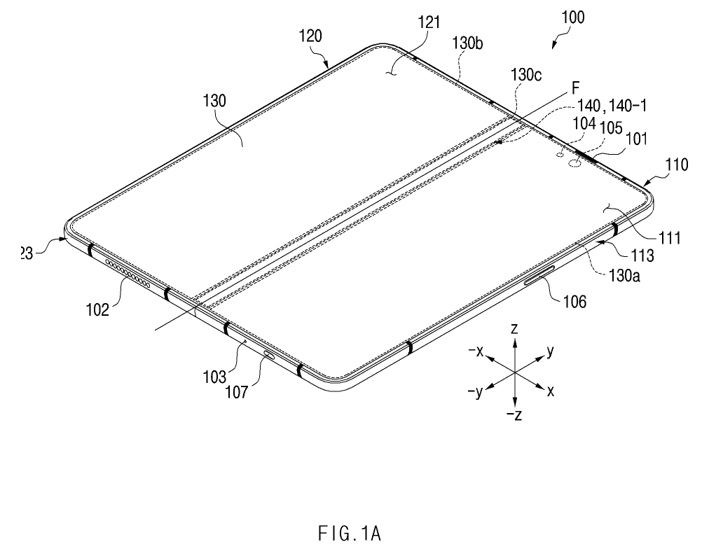

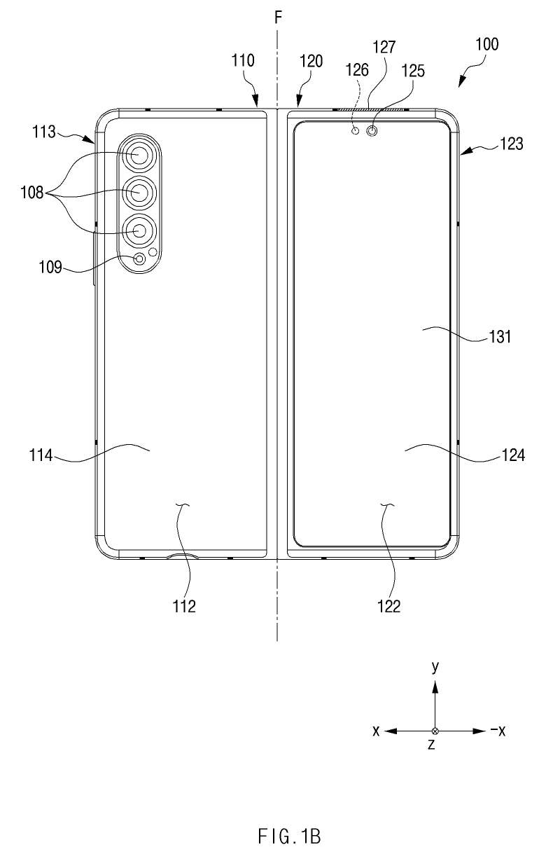

FIG. 1A is a front perspective view of an electronic device according to an embodiment.

FIG. 1B is a plan view illustrating a rear surface of an electronic device according to an embodiment.

Referring to FIGS. 1A and 1B, according to an embodiment, an electronic device 100 may include a first housing 110 (e.g., a first housing structure) including a first side member 113 (e.g., a side bezel), and a second housing 120 (e.g., a second housing structure) including a second side member 123 (e.g., a side bezel), which are coupled to be foldable with respect to each other by means of at least one hinge device 140 and/or 140-1 (e.g., a hinge module or a hinge structure), with respect to a folding axis F. For example, the first housing 110 and the second housing 120 may be configured as a foldable housing (e.g., a housing structure). For example, the electronic device 100 may include a first display 130 (e.g., a flexible display, a foldable display, or a main display) arranged to be supported by the first housing 110 and the second housing 120. For example, the first housing 110 may include a first surface 111 and a second surface 112 facing away from the first surface 111 (e.g., in the -z axis direction). For example, the second housing 120 may include a third surface 121 and a fourth surface 122 facing away from the third surface 121 (e.g., in the -z-axis direction). For example, the first housing 110 may include a first rear cover 114 coupled to the first side member 113. For example, the second housing 120 may include a second rear cover 124 coupled to a second side member 123. For example, when the electronic device 100 is in a fully unfolded first state (e.g., an unfolded state or an unfolding state), the electronic device 100 may operate such that the first surface 111 and the third surface 121 face substantially the same direction (e.g., the z-axis direction). For example, when the electronic device 100 is in a fully folded second state (e.g., a folded state or a folding state), the electronic device 100 may operate such that the first surface 111 and the third surface 121 face each other or face the opposite directions. For example, the electronic device 100 may be operated to maintain a third state (e.g., an intermediate state) between the first state and the second state.

According to an embodiment, the electronic device 100 may include a first receiver 101 disposed through the first surface 111 of the first housing 110, at least one first sensor module 104 (e.g., an illuminance sensor), and/or at least one first camera module 105 (e.g., an under display camera (UDC)). For example, the electronic device 100 may include at least one key 106 disposed on the first side member 113. For example, the electronic device 100 may include at least one second camera module 108 and/or a flash 109 disposed through the second surface 112 (e.g., the first rear cover 114) of the first housing 110. For example, the electronic device 100 may include a second display 131 disposed on the fourth surface 122 of the second housing 120, at least one third camera module 125 (e.g., an under display camera (UDC)), at least one second sensor module 126, and/or a second receiver 127. For example, the second display 131 may be disposed to be visible from the outside through at least a portion of the second rear cover 124. For example, the electronic device 100 may include a speaker 102 disposed through the second side member 123, a microphone 103 disposed through the first side member 113, and/or a connector port 107. At least some of the above-described components may be disposed in the first housing 110 and/or the second housing 120.

According to an embodiment, the first display 130 (e.g., a flexible display) may include a first area 130a (e.g., a first flat portion) corresponding to at least a portion of the first surface 111, a second area 130b (e.g., a second flat portion) corresponding to at least a portion of the third surface 121, and a third area 130c (e.g., a flexible portion) that connects the first area 130a and the second area 130b, in which the electronic device 100 is deformed from the second state (e.g., a folding state) and/or the third state. For example, the third area 130c may be disposed at a position at least partially overlapping the at least one hinge device 140 or 140-1, when the first display 130 is viewed from above (e.g., in the z-axis direction). For example, in the second state, the first display 130 may be disposed such that the first surface 111 and the third surface 121 face each other and are not visible from the outside (e.g., an in-folding type). For example, in the second state, the first display 130 may be disposed such that the first surface 111 and the third surface 121 face the directions opposite to each other, thereby being visible from the outside (e.g., an out-folding type).

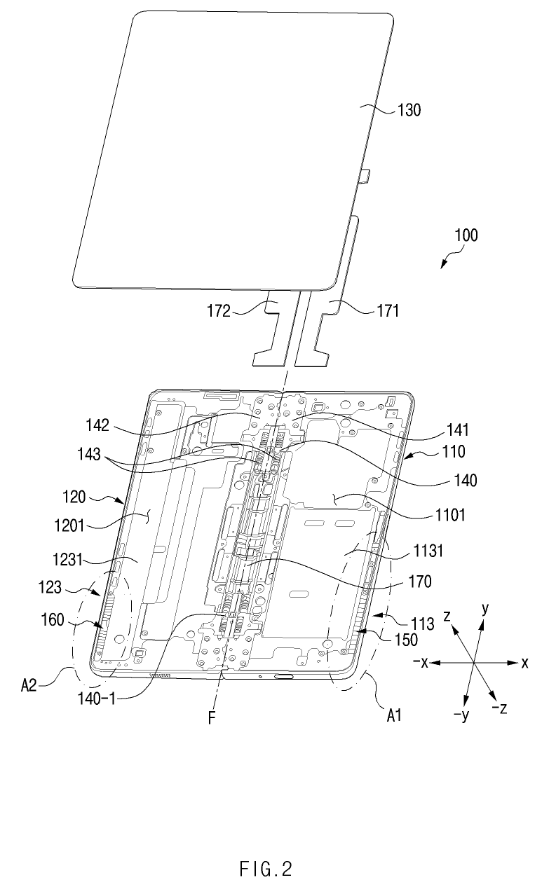

FIG. 2 is a partial exploded perspective view of an electronic device of FIGS. 1A and 1B including a hinge device according to various embodiments of the disclosure.

Referring to FIG. 2, according to an embodiment, the electronic device 100 may include at least one hinge device 140 and 140-1 (e.g., a hinge module or a hinge structure) connecting the first housing 110 and the second housing 120 underneath the first display 130 (e.g., in the -z axis direction). For example, the at least one hinge device 140 and 140-1 may include a first hinge device 140 and a second hinge device 140-1 spaced apart from the first hinge device 140 along a direction (e.g., ± y-axis direction) parallel to the folding axis F. For example, the at least one hinge device 140 and/or 140-1 may be supported by a first support member 1131 extending from the first side member 113 to a first space 1101 of the first housing 110 and a second support member 1231 extending from the second side member 123 to a second space 1201 of the second housing 120. For example, the at least one hinge device 140 and/or 140-1 may be disposed between the first housing 110 and the second housing 120 so as not to be visible from the outside through the hinge housing 170 (e.g., a hinge cover).

According to an embodiment, the first hinge device 140 may include a first rotation member 141 (e.g., a first arm or a first rotator) disposed on the first support member 1131 of the first housing 110, a second rotation member 142 (e.g., a second arm or a second rotator) disposed on the second support member 1231 of the second housing 120, and a gear assembly 143 connecting the first rotation member 141 and the second rotation member 142 and coupling the first housing 110 and the second housing 120 to rotate symmetrically with respect to each other. For example, the gear assembly 143 may include a plurality of gears (e.g., spur gears and/or worm gears) meshed with respect to each other. For example, the gear assembly 143 may include a cam coupling structure configured to pressurize the first housing 110 and the second housing 120 in a direction to be shifted from the first state (e.g., an unfolded state or an unfolding state) to the second state (e.g., a folded state or a folding state) or a direction to be shifted from the second state to the first state, relative to a certain angle to each other, and to provide a sense of stopping at various folding angles. For example, the second hinge device 140-1 may have substantially the same configuration as the first hinge device 140.

According to an embodiment, the electronic device 100 may include a first hinge plate 171 connected to a first support member 1131 and/or a first rotation member 141. The electronic device 100 may include a second hinge plate 172 connected to a second support member 1231 and/or a second rotation member 142. For example, the at least one hinge device 140 and/or 140-1, the first rotation member 141, the second rotation member 142, the first hinge plate 171, and the second hinge plate 172 may form substantially the same plane as the first support member 1131 and the second support member 1231, when the electronic device 100 is in the first state. For example, the second hinge device 140-1 may be substantially symmetrical to the first hinge device 140 or may have substantially the same configuration.

In an embodiment, the electronic device 100 may include a first magnetic module 150 disposed in the first housing 110 and a second magnetic module 160 disposed in the second housing 120. The first magnetic module 150 may be disposed in the first space 1101 of the first housing 110, and the second magnetic module 160 may be disposed in the second space 1201 of the second housing 120. The first magnetic module 150 and the second magnetic module 160 may be disposed at positions symmetrical with respect to the folding axis F in a first state (e.g., the unfolded state) of the electronic device 100. For example, the first magnetic module 150 may be disposed at a position spaced apart from the folding axis F in the x-axis direction by a predetermined distance, and the second magnetic module 160 may be disposed at a position spaced apart from the folding axis F in the -x-axis direction by a distance equal to the distance. For example, the first magnetic module 150 may be disposed in a space A1 adjacent to one edge of the first side member 113 that is furthest from the folding axis F in the x-axis direction (e.g., the inner edge of the first side member 113). For example, the second magnetic module 160 may be disposed in a space A2 adjacent to one edge of the second side member 123 that is furthest from the folding axis F in the -x-axis direction (e.g., the inner edge of the second side member 123). The first magnetic module 150 and the second magnetic module 160 may be disposed at corresponding positions so that a magnetic force (e.g., an attractive force) may be generated between them in a second state (e.g., the folded state) of the electronic device 100.

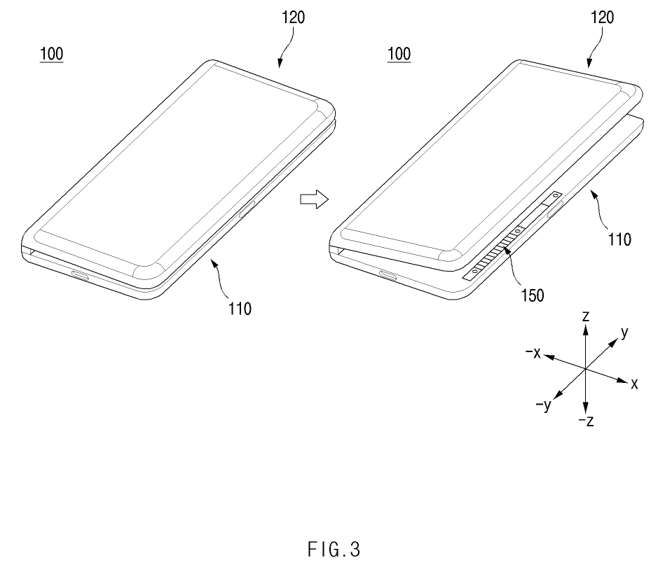

FIG. 3 are perspective views illustrating a part of a process of unfolding an electronic device from a folded state according to an embodiment.

Referring to FIG. 3, in an embodiment, in a second state (e.g., the folded state) of the electronic device 100 illustrated in the left figure in FIG. 3, the first magnetic module 150 and a second magnetic module (e.g., the second magnetic module 160 in FIG. 2) may be at least partially overlapped. For example, in the second state, the first magnetic module 150 and the second magnetic module 160 may overlap at least partially on the z-axis and exert an attractive force on each other. From the second state, the attractive force acting between the first magnetic module 150 and the second magnetic module 160 may be reduced, and as the first housing 110 or the second housing 120 rotates around the folding axis F, the electronic device 100 may change to a first state (e.g., the unfolded state) through a third state (e.g., the intermediate state). In the third state of the electronic device 100 illustrated in the right figure in FIG. 3, the first housing 110 and the second housing 120 may be rotated away from each other as the first magnetic module 150 is moved in a direction in which the attractive force with the second magnetic module 160 decreases. For example, the third state may be a state where the first surface of the first housing 110 (e.g., the first surface 111 in FIG. 1A) and the third surface of the second housing 120 (e.g., the third surface 121 in FIG. 1A) form a specified angle with each other (e.g., an angle greater than 0 degrees and less than 180 degrees).

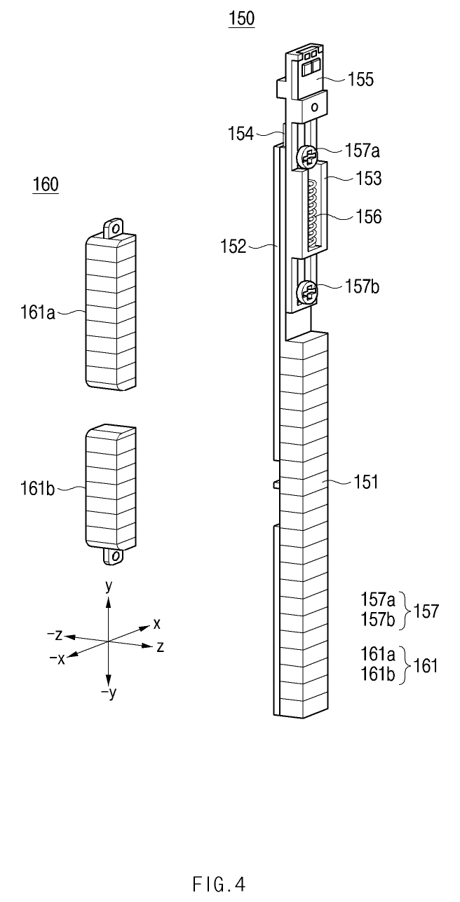

FIG. 4 are perspective views illustrating an example of shapes of a first magnetic module and a second magnetic module according to an embodiment.

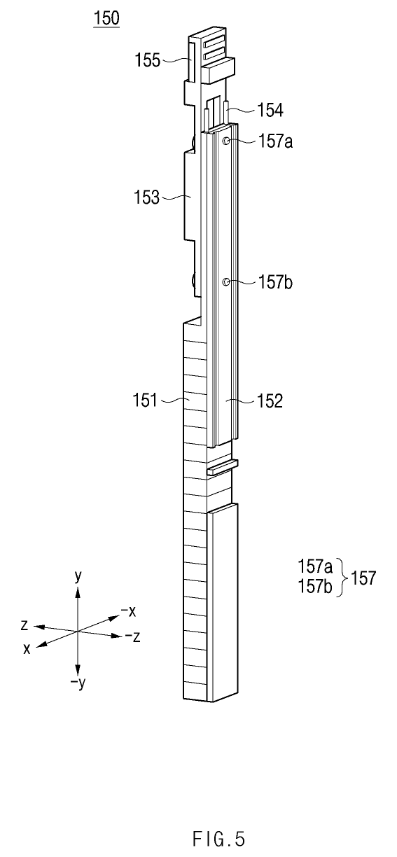

FIG. 5 is a perspective view illustrating a shape of the first magnetic module in FIG. 4 as viewed from a different angle.

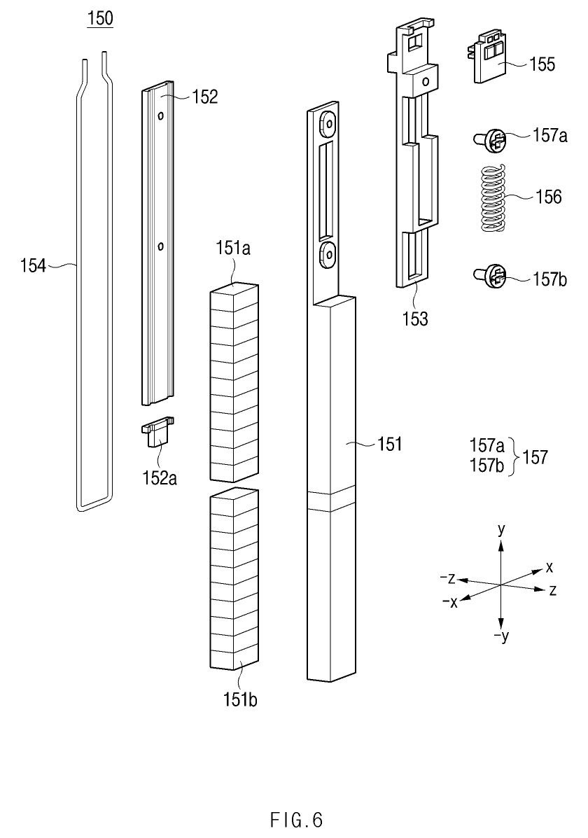

FIG. 6 is an exploded perspective view of the first magnetic module of the electronic device according to an embodiment.

Referring to FIGS. 4 to 6, in an embodiment, the first magnetic module 150 may include a first magnetic body housing 151, a wire housing 152, a wire driving unit 153, a wire 154, a feeding unit 155, a first elastic member 156, and a fastening member 157. The second magnetic module 160 may include a second magnetic body housing 161.

The wire 154 may be extended in a first direction (e.g., in the y-axis direction). For example, the wire 154 may include two portions extending in a first direction (e.g., in the y-axis direction) and a portion extending in a direction perpendicular to the first direction (e.g., in the x-axis direction) and connecting the two portions. The wire 154 may be formed at least partially parallel to the folding axis (e.g., the folding axis F in FIG. 1A). The wire 154 may be at least partially accommodated in the wire housing 152. One end of the wire 154 that is not accommodated in the wire housing 152 may be coupled to the wire driving unit 153, and the other end opposite to the one end (e.g., a portion extending in the x-axis direction) may be coupled to a wire fixing portion 152a of the wire housing 152. The wire 154 may be formed from a metal material. For example, the wire 154 may be formed from a shape memory alloy (e.g., SMA). For example, the wire 154 may be formed of nitinol (e.g., a nickel-titanium alloy). When current is supplied to the wire 154, its temperature increases and its length may change (e.g., contracted). As an example, the wire 154 may be contracted by a certain percentage (e.g., 3% to 5%) when the wire 154 reaches a certain temperature (e.g., 90 degrees Celsius). A component (e.g., the wire housing 152 and/or the first magnetic body housing 151) connected to the wire 154 may be moved in a longitudinal direction of the wire 154 (e.g., the y-axis direction) by a tensile force (e.g., a compressive force of 5 N or more) generated when the wire 154 is contracted. In an embodiment, a diameter of the wire 154 (e.g., a width of the cross-section cut along the x-axis) may be related to a contraction time or recovery time of the wire 154, and may be formed as a diameter that may implement an appropriate contraction time or recovery time considering the usability of the user. For example, the diameter of the wire 154 may be formed into several hundred micrometers (e.g., 150 micrometers).

The wire housing 152 may be extended in the first direction (e.g., in the y-axis direction). For example, the wire housing 152 may have a length in the first direction that is smaller than a length of the wire 154 in the first direction to accommodate at least a portion of the wire 154 (e.g., a portion excluding both ends of the wire 154). In the wire housing 152, a step (e.g., a groove or a notch) that may accommodate at least a portion of the wire 154 may be formed. The wire housing 152 may include the wire fixing portion 152a coupled to an opposite end (e.g., an end in the -y-axis direction) to one end coupled to the wire driving unit 153 of the wire 154. For example, when the wire housing 152 is formed of two separate parts, the wire fixing portion 152a may be a portion formed to be smaller to accommodate only a portion adjacent to the other end of the wire 154. For example, the wire fixing portion 152a may be formed in various shapes to be interlocked with (or coupled to) the wire 154. In an embodiment, the wire housing 152 may be formed of a composite material. For example, the wire housing 152 may be formed of fiber reinforced plastic (e.g., glass fiber reinforced plastic (GFRP)). In an embodiment, the wire housing 152 may be coupled to the first magnetic body housing 151 so that they are integrally formed.

The first magnetic body housing 151 may be disposed above the wire housing 152 (e.g., in the z-axis direction). For example, one end (e.g., an end in the y-axis direction) of the first magnetic body housing 151 may be disposed to be aligned with one end (e.g., an end in the y-axis direction) of the wire housing 152. One surface of the first magnetic body housing 151 (e.g., a surface facing the -z axis) may be coupled to the wire housing 152 to form one housing. The first magnetic body housing 151 may be extended in the first direction (e.g., the y-axis direction) and may include a portion that accommodates at least one magnetic body (e.g., magnet). For example, the first magnetic body housing 151 may be formed to accommodate magnetic bodies arranged in the first direction. For example, the first magnetic body housing 151 may include a portion that accommodates first-first magnetic bodies 151a (e.g., upper magnetic bodies) and first-second magnetic bodies 151b (e.g., lower magnetic bodies) composed of a plurality of magnets together. For example, the first magnetic body housing 151 may be formed as a single housing (e.g., packaging) that accommodates the first-first magnetic bodies 151a and the first-second magnetic bodies 151b. Since the first magnetic body housing 151 is formed as a single housing and moved, a change in the magnetic force acted between the first magnetic module 150 and the second magnetic module 160 may be clearly observed compared to a case where the housings accommodating the first-first magnetic bodies 151a or the first-second magnetic bodies 151b are separately formed.

A portion of the first magnetic body housing 151 excluding a portion that accommodates at least one magnetic body may be connected to the wire driving unit 153. For example, the first magnetic body housing 151 may be physically connected to the wire driving unit 153 through the fastening member 157. In an embodiment, the first magnetic body housing 151 may be formed of a composite material. For example, the first magnetic body housing 151 may be formed of fiber reinforced plastic (e.g., GFRP). The first magnetic body housing 151 may be moved in a first housing (e.g., the first housing 110 in FIG. 1A). For example, the first magnetic body housing 151 may be moved in a direction in which the first magnetic body housing 151 is aligned with the second magnetic body housing 161 to exert an attractive force on each other, or may be moved in a direction in which the first magnetic body housing 151 is at least partially spaced from the second magnetic body housing 161 to exert a repulsive force on each other.

The wire driving unit 153 may be disposed so that at least a portion thereof is disposed above the first magnetic body housing 151 (e.g., in the z-axis direction). For example, the wire driving unit 153 may be disposed to be at least partially aligned to the first magnetic body housing 151 along the z-axis. The wire driving unit 153 may be extended in the first direction (e.g., in the y-axis direction). The length of the wire driving unit 153 in the first direction may be formed to be longer than the length of a portion of the first magnetic body housing 151 excluding the portion that accommodates the magnetic bodies in the first direction. The wire driving unit 153 may be connected to the first magnetic body housing 151 and the fastening member 157. For example, the wire driving unit 153 may include one or more connection points (e.g., fastening points) connected to the first magnetic body housing 151. In an embodiment, the wire driving unit 153 may be formed of a composite material. For example, the wire driving unit 153 may be formed of fiber reinforced plastic (e.g., GFRP). The wire driving unit 153 may be at least partially fastened to the first housing (e.g., the first housing 110 in FIG. 1A). For example, the wire driving unit 153 may be at least partially fixed to the first housing 110, so that the first magnetic body housing 151 may be moved without slipping on the first housing 110.

The feeding unit 155 may be disposed on the wire driving unit 153 (e.g., in the z-axis direction). For example, the feeding unit 155 may be seated on or coupled to the wire driving unit 153. The feeding unit 155 may be in contact with the wire 154, and may be physically and/or electrically connected to the wire 154. The current supplied to the wire 154 through the feeding unit 155 may be adjusted. By adjusting the current supplied to the wire 154, the contracted or relaxed state of the wire 154 may be determined or obtained, and a direction of movement of the first magnetic body housing 151 may be determined or obtained.

The fastening member 157 may be disposed so that the wire driving unit 153 and the first magnetic body housing 151 are at least partially coupled thereto. For example, the fastening member 157 may be disposed on the wire driving unit 153 (e.g., in the z-axis direction) and formed to pass through at least a portion of the wire driving unit 153 and the first magnetic body housing 151. As an example, the fastening member 157 may be formed in a screw shape. In an embodiment, the fastening member 157 may include a pair of fastening members (e.g., a first fastening member 157a and a second fastening member 157b).

The first elastic member 156 may have a shape of being extended in the first direction (e.g., in the y-axis direction). One end (e.g., an end in the y-axis direction) of the first elastic member 156 may be coupled to the first magnetic body housing 151, and the other end (e.g., an end in the -y-axis direction) may be coupled to the wire driving unit 153. The first elastic member 156 may be disposed parallel to a portion of the wire driving unit 153 (e.g., parallel in the y-axis direction). For example, the first elastic member 156 may be disposed between the first fastening member 157a and the second fastening member 157b. The first elastic member 156 may be formed in a spring shape.

The second magnetic module 160 may include at least one magnetic body. For example, the second magnetic module 160 may include a housing that accommodates a plurality of magnets. For example, the second magnetic module 160 may include the second magnetic body housing 161 that is extended in the first direction (e.g., in the y-axis direction). For example, the second magnetic module 160 may include a second-first magnetic body housing 161a (e.g., an upper magnetic body housing) and a second-second magnetic body housing 161b (e.g., a lower magnetic body housing), each of which includes a plurality of magnets and is spaced apart from the other in the y-axis direction.

The magnetic bodies accommodated in the first magnetic body housing 151 and the magnetic bodies accommodated in the second magnetic body housing 161 may be configured so that the magnetic force (e.g., the attractive force) acted between the first magnetic module 150 and the second magnetic module 160 is maximized. For example, the magnetic bodies accommodated in the first-first magnetic bodies 151a, the first-second magnetic bodies 151b, the second-first magnetic body housing 161a, and the magnetic bodies accommodated in the second-second magnetic body housing 161b may be disposed in a Halbach arrangement or in another similar type of arrangement.

The unfolding operation (e.g., an operation from the second state to the first state) of the electronic device (e.g., the electronic device 100 in FIG. 1A) may be started by the movement of the first magnetic body housing 151 in a direction in which the attractive force against the second magnetic body housing 161 decreases. For example, the first magnetic body housing 151 may be moved in the first direction (e.g., in the y-axis direction) within the first housing (e.g., the first housing 110 in FIG. 1A). The folding operation of the electronic device 100 (e.g., an operation from the first state to the second state) may be completed by the movement of the first magnetic body housing 151 in a direction in which the attractive force toward the second magnetic body housing 161 increases (e.g., in the -y-axis direction).

In an embodiment, the first magnetic module 150 may have a shape in which the above-described components are stacked in one direction (e.g., in the z-axis direction). For example, along the z-axis, the first magnetic body housing 151 may be disposed on the wire housing 152 that accommodates the wire 154, and the wire driving unit 153 may be disposed on the first magnetic body housing 151. The feeding unit 155 may be disposed on one side of the wire driving unit 153, and the fastening member 157 may be disposed on the other side. The first elastic member 156 may be disposed on the first magnetic body housing 151, or may be disposed parallel to the wire driving unit 153 in the y-axis direction.

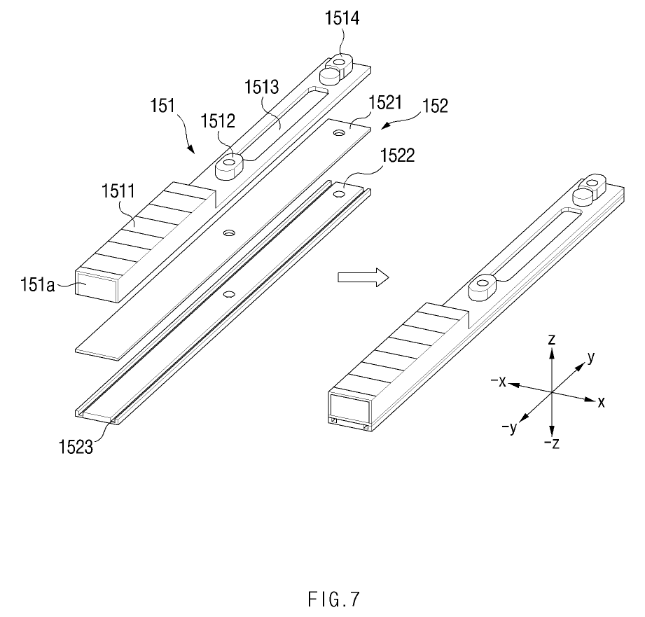

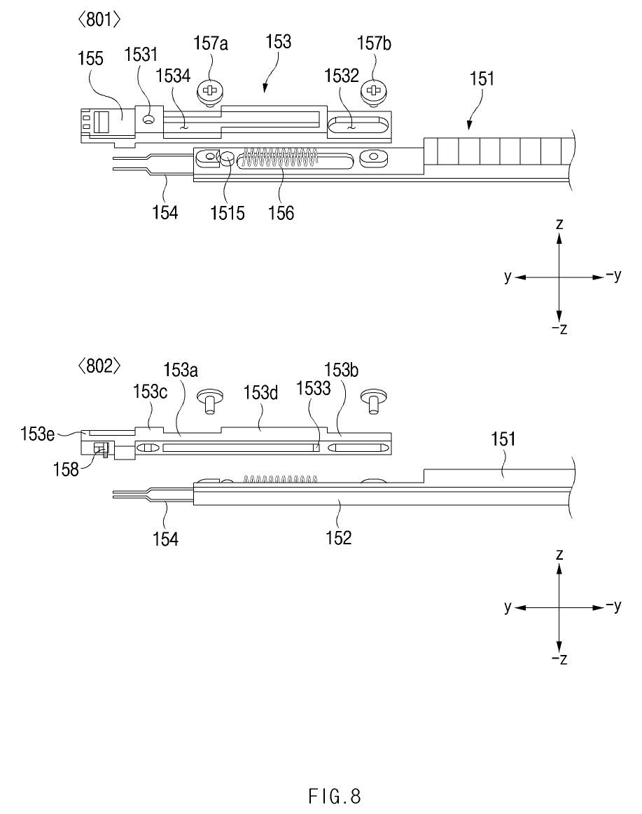

FIG. 7 are perspective views illustrating a portion of a coupled structure of a first magnetic module according to an embodiment.

FIG. 7 is a view illustrating a coupled structure of the first magnetic body housing 151 and the wire housing 152. For convenience of description, FIG. 7 illustrates only a portion of a coupled structure of the first magnetic body housing 151 and the wire housing 152 (e.g., a coupled structure of a portion of the first magnetic body housing 151 excluding the portion where the first-second magnetic bodies 151b are accommodated and a portion of the wire housing 152).

Referring to FIG. 7, in an embodiment, the wire housing 152 may include an upper plate 1521 and a lower plate 1522 having a step 1523 (e.g., a groove or recess) formed therein. At least a portion of a wire (e.g., the wire 154 in FIG. 4) may be accommodated in the step 1523 formed on the lower plate 1522. In an embodiment, the upper plate 1521 may be formed to have a thinner width in the z-axis direction than a width of the lower plate 1522 in the z-axis direction (e.g., 0.4 mm). For example, the upper plate 1521 may be formed to have a thinner width (e.g., 0.05 mm) in the z-axis direction than a depth (e.g., 0.3 mm) of the step 1523 in the z-axis direction. The step 1523 may be formed to be extended from one end of the lower plate 1522 in the y-axis direction to the other end, and may be formed in a shape corresponding to the number and/or shape of the wire 154. The width of the step 1523 in the z-axis direction may be formed to be larger than the diameter of the wire (e.g., the wire 154 in FIG. 4). For example, the step 1523 may be formed with a sufficient depth to accommodate the wire 154. In an embodiment, a heat transfer material may be disposed on at least a portion of the wire housing 152 that accommodates the wire 154. For example, a heat transfer material may be disposed on the step 1523 formed on the lower plate 1522, and the speed of heating or cooling of the wire 154 may be increased when current is supplied to the wire 154 or when the supply of current is cut off. By disposing the heat transfer material, the unfolding or folding operation of the electronic device (e.g., the electronic device 100 in FIG. 1A) may be quickly performed.

In an embodiment, the first magnetic body housing 151 and the wire housing 152 may be formed separately and then coupled. For example, the first magnetic body housing 151, the upper plate 1521, and the lower plate 1522 may be separately formed. The first magnetic body housing 151, the upper plate 1521, and the lower plate 1522 may be coupled to each other by thermal bonding in a state of being aligned in one direction (e.g., in the z-axis direction). For example, by thermal bonding in a state (e.g., a form illustrated on the left side in FIG. 7) where the upper plate 1521 and the first magnetic body housing 151 are sequentially aligned (e.g., in the z-axis direction) on top of the lower plate 1522, a single housing (e.g., a form illustrated on the right side in FIG. 7) may be integrally formed. Alternatively, in an embodiment, the lower plate 1522, the upper plate 1521, and the first magnetic body housing 151 may be coupled with the wire 154 accommodated in the step 1523 of the lower plate 1522. In an embodiment, the contents disclosed herein regarding the movement (or driving) of the first magnetic body housing 151 may be understood as movement (or driving) of the integrated housing in which the first magnetic body housing 151 and the wire housing 152 are coupled.

The first magnetic body housing 151 may include a region that at least partially overlaps with the wire driving unit (e.g., the wire driving unit 153 in FIG. 4) in the z-axis direction. For example, the first magnetic body housing 151 may include portions (e.g., 1512 and 1514) connected to the wire driving unit 153 through a fastening member (e.g., the fastening member 157 in FIG. 4). Between the portions 1512 and 1514 connected to the wire driving unit 153 of the first magnetic body housing 151, a fine-shaped recess 1513 may be formed in the -z-axis direction so that a first elastic member (e.g., the first elastic member 156 in FIG. 4) may be seated. For example, on an upper surface (e.g., the surface facing the z-axis direction) of the first magnetic body housing 151, a first portion 1511 for accommodating the first-first magnetic bodies 151a in the y-axis direction, a second portion 1512 connected to the wire driving unit 153, the recess 1513, and a third portion 1514 connected to the wire driving unit 153 may be sequentially formed.

FIG. 8 are perspective views illustrating another portion of the coupled structure of the first magnetic module according to an embodiment.

FIG. 8 are perspective views illustrating a coupled structure of the first magnetic body housing 151, the wire driving unit 153, the wire 154, and the feeding unit 155. For convenience of description, in FIG. 8, the illustration of a portion of the first magnetic body housing 151 and a portion of the wire housing 152 that are located in a region not coupled to the wire driving unit 153 is omitted. Reference number <801> in FIG. 8 is a form of the coupled structure as viewed obliquely in the z-axis direction, and reference number <802> is a form of the coupled structure as viewed obliquely in the -z-axis direction.

Referring to FIG. 8, in an embodiment, the wire driving unit 153 may include portions a first seating portion 153a and a second seating portion 153b on which the pair of fastening members 157a and 157b are seated, a fixing portion 153c that is fixed to a first housing (e.g., the first housing 110 in FIG. 1A), an accommodating portion 153d that surrounds at least a portion of the first elastic member 156, and a third seating portion 153e on which the feeding unit 155 is seated. For example, the wire driving unit 153 may be provided in a form in which the second seating portion 153b on which the second fastening member 157b is seated, the accommodating portion 153d that surrounds the first elastic member 156, the first seating portion 153a on which the first fastening member 157a is seated, the fixing portion 153c that is fixed to the first housing 110, and the third seating portion 153e on which the feeding unit 155 is seated are stepped from each other (e.g., with different widths in the z-axis direction) in one direction (e.g., in the y-axis direction).

The first fastening member 157a may be coupled to the third portion (e.g., the third portion 1514 in FIG. 7) of the first magnetic body housing 151 through an opening 1534 formed across the accommodating portion 153d and the first seating portion 153a of the wire driving unit 153. A second fastening member 157b may be coupled to the second portion (e.g., the second portion 1512 in FIG. 7) of the first magnetic body housing 151 through an opening 1532 formed in the second seating portion 153b of the wire driving unit 153. The feeding unit 155 may be coupled to the third seating portion 153e of the wire driving unit 153. The feeding unit 155 may be electrically connected to the wire 154 by being coupled through an opening formed at a lower end of the third seating portion 153e (e.g., one end in the -z-axis direction). In an embodiment, the wire driving unit 153 may be at least partially fixed to the first housing 110. For example, a hole 1531 may be formed in the fixing portion 153c of the wire driving unit 153. A fixing member (not illustrated) coupled to the first housing 110 may be disposed in the hole 1531 formed in the fixing portion 153c of the wire driving unit 153. The wire driving unit 153 and the first housing 110 may be fixed to each other through the fixing member, and a relative movement of the first magnetic body housing 151 with respect to the first housing 110 may be implemented.

In an embodiment, the first elastic member 156 may have one end in the y-axis direction that is coupled to the first magnetic body housing 151, and the other end in the -y-axis direction that is coupled to the wire driving unit 153. The one end of the first elastic member 156 may be coupled to the third portion (e.g., the third portion 1514 in FIG. 7) formed at one end of the first magnetic body housing 151 in the y-axis direction. As an example, the third portion 1514 of the first magnetic body housing 151 may include a portion 1515 formed to be engaged with (or be coupled to) the first elastic member 156. The other end of the first elastic member 156 may be coupled to an end 1533 of the lower end (e.g., one end in the -z-axis direction) of the accommodating portion 153d of the wire driving unit 153 in the -y-axis direction. The first elastic member 156 may be disposed in a recess (e.g., the recess 1513 in FIG. 7) formed in the first magnetic body housing 151. In an example, at least a portion of the first elastic member 156 may be accommodated within an opening formed in the wire driving unit 153 (e.g., the opening 1534 formed in the accommodating portion 153d and the first seating portion 153a of the wire driving unit 153).

The wire 154 may be at least partially disposed between the first magnetic body housing 151 and the wire housing 152. One end of the wire 154 facing the feeding unit 155 (e.g., the end facing the y-axis) may be coupled to the feeding unit 155. The wire 154 may be electrically connected to the feeding unit 155 by being coupled to a second elastic member 158 disposed on a lower portion of the feeding unit 155 (e.g., in the -z axis). The other end of the wire 154 (e.g., the end facing the -y axis) may be coupled to a wire fixing portion of the wire housing 152 (e.g., the wire fixing portion 152a in FIG. 6).

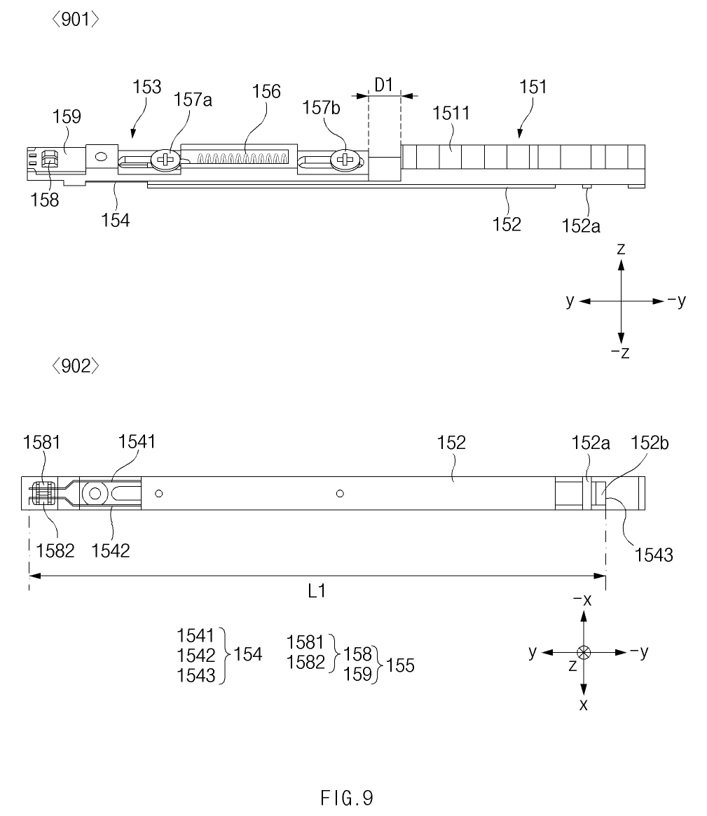

FIG. 9 are perspective and top-down views illustrating a wire relaxed state of the first magnetic module including the wire according to an embodiment.

Reference number <901> in FIG. 9 represents a form of the first magnetic module (e.g., the first magnetic module 150 in FIG. 4) in a state where the length of the wire 154 (e.g., the length in the y-axis direction) is not contracted. In the above state, the attractive force may be acted between the first magnetic module 150 and the second magnetic module (e.g., the second magnetic module 160 in FIG. 4) so that a second state (e.g., the folded state) of an electronic device (e.g., the electronic device 100 in FIG. 1A) may be maintained. Hereinafter, a state where the length of the wire 154 is not contracted (e.g., a state where the length of the wire 154 is restored, or a state where no current flows through the wire 154) is referred to as a relaxed state (or a first state of the wire 154). Reference number <902> in FIG. 9 represents a form of the first magnetic module 150 in a relaxed state as viewed from the -z axis. In an example, the relaxed state of the wire 154 may occur in both the first state (e.g., the unfolded state) and the second state (e.g., the folded state) of the electronic device 100. For example, the wire 154 may be maintained in the relaxed state at all times except for a starting point of the unfolding operation of the electronic device 100 (e.g., from a time point when current is supplied to the wire 154 to a time point when current is cut off).

Referring to FIGS. 1A to 9, in an embodiment, the length (e.g., the length in the y-axis direction) of the wire (e.g., the wire 154 in FIG. 6) in the relaxed state may be formed to be a first length L1. In the relaxed state, one end (e.g., an end in the -y-axis direction) of the wire driving unit 153 may be spaced apart from the first portion 1511 that accommodates the magnetic bodies of the first magnetic body housing 151 by a first distance D1. The first fastening member 157a may be seated on a portion of a third portion (e.g., the first seating portion 153a in FIG. 8) of the wire driving unit 153 adjacent to the -y axis. The second fastening member 157b may be seated on a portion of a first portion (e.g., the second seating portion 153b in FIG. 8) of the wire driving unit 153 adjacent to the -y axis. For example, the second fastening member 157b may be brought into contact with one end of the opening 1532 formed in the first portion 153b of the wire driving unit 153 toward the -y axis. The first elastic member 156 may be maintained in the relaxed state (e.g., an undeformed state).

In an embodiment, the feeding unit 155 may include the second elastic member 158 coupled to the wire 154 and a substrate 159 on which the second elastic member 158 is disposed. One end (e.g., an end in the y-axis direction) of the wire 154 may be coupled to the second elastic member 158. For example, the wire 154 may include two portions 1541 and 1542 extended parallel to the y-axis and a portion 1543 extended parallel to the x-axis to connect the two portions 1541 and 1542. For example, the two portions 1541 and 1542 of the wire 154 may be respectively coupled to two separate portions 1581 and 1582 of the second elastic member 158. The other end 1543 of the wire 154 (e.g., an end in the -y-axis direction) may be coupled to the wire fixing portion 152a formed to be parallel to the wire housing 152 in the y-axis direction. For example, the other end 1543 of the wire 154 may be engaged with an engaging portion 152b formed to have a width in the x-axis direction that is smaller than the width of the wire 154 of the wire fixing portion 152a in the x-axis direction.

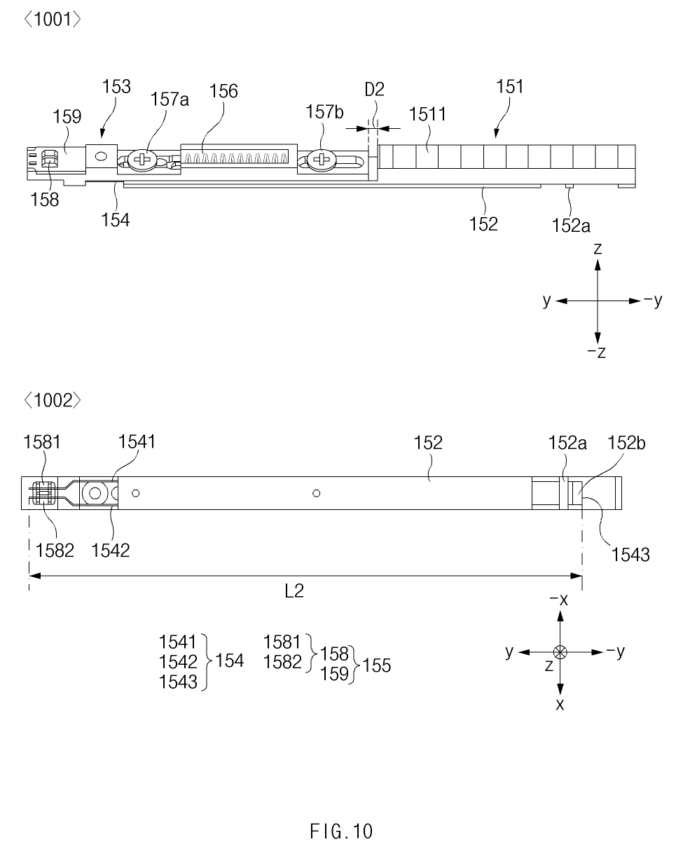

FIG. 10 are perspective and top-down views illustrating a wire contracted state of the first magnetic module including a wire according to an embodiment.

Reference number <1001> in FIG. 10 represents a form of the first magnetic module (e.g., the first magnetic module 150 in FIG. 4) in a state where the length of the wire 154 (e.g., the length in the y-axis direction) is contracted. In the above state, the attractive force acting between the first magnetic module 150 and the second magnetic module (e.g., the second magnetic module 160 in FIG. 4) is reduced, so that a first state (e.g., the unfolded state) of the electronic device (e.g., the electronic device 100 in FIG. 1A) may be induced. Hereinafter, a state where the length of the wire 154 is contracted (e.g., a state where current is supplied to the wire 154) is referred to as a contracted state (or the second state of the wire 154). Reference number <1002> in FIG. 10 represents a form of the first magnetic module 150 in the contracted state as viewed from the -z axis. In an example, the contracted state of the wire 154 may occur at a starting point of the unfolding operation of the electronic device 100 (e.g., from a time point when current is supplied to the wire 154 to a time point when current is cut off).

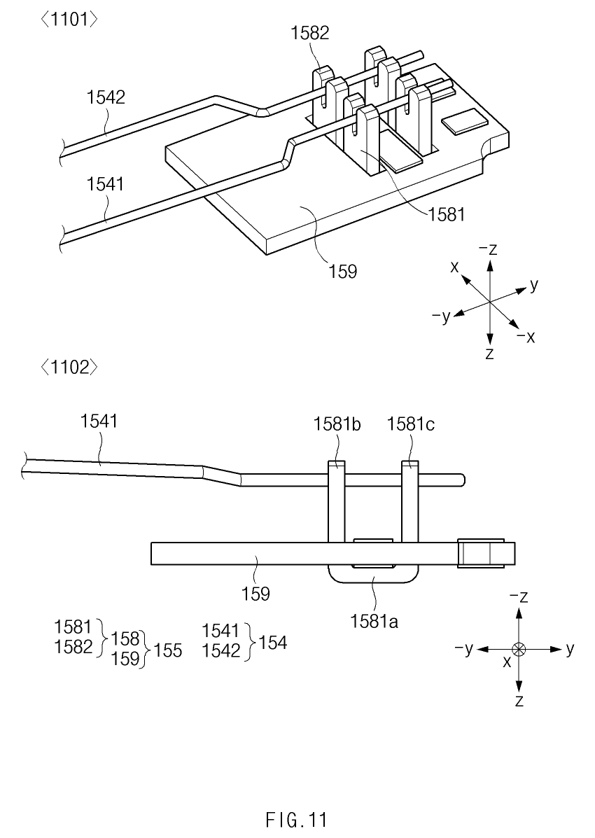

Referring to FIGS. 1A to 10, in an embodiment, the length of the wire 154 may change during the unfolding operation of the electronic device 100 (e.g., the operation of unfolding the electronic device 100 from the second state to the first state). For example, when current is applied from the substrate 159 of the feeding unit 155 to a shape memory alloy included in the wire 154, the length of the wire 154 (e.g., the length in the y-axis direction) may be contracted. As an example, the length of the wire 154 in the y-axis direction may be contracted to a second length L2 that is smaller than a first length (e.g., the first length L1 in FIG. 9). In an embodiment, the lengths of a first wire 1541 and a second wire 1542 coupled to the second elastic member 158 electrically connected to the substrate 159 may be contracted in the y-axis direction. As the first wire 1541 and the second wire 1542 contract, respective portions 1581 and 1582 of the second elastic member 158 coupled to the first wire 1541 and the second wire 1542 may be formed to deform, which will be described in detail in FIG. 11 and below.

As the length of the wire 154 contracts, the first magnetic body housing 151 coupled to the other end 1543 of the wire 154 may be moved within the first housing (e.g., the first housing 110 in FIG. 1A). For example, the first magnetic body housing 151 may be moved in a direction in which the attractive force with respect to the second magnetic body housing (e.g., the second magnetic body housing 161 in FIG. 4) is reduced. For example, a portion of the first magnetic body housing 151 that overlaps the wire driving unit 153 fixed to the first housing 110 in the z-axis direction may be increased.

In an embodiment, one end (e.g., an end in the -y-axis direction) of the wire driving unit 153 may be spaced apart from the first portion 1511 that accommodates the magnetic bodies of the first magnetic body housing 151 by a second distance D2. For example, as the first magnetic body housing 151 is moved in the first direction (e.g., in the y-axis direction), the second distance D2 may be reduced compared to a first distance (e.g., the first distance D1 in FIG. 9) of the first magnetic module 150 in the second state (e.g., the folded state). The first coupling member 157a and the second coupling member 157b may be moved in the y-axis direction inside the wire driving unit 153. For example, the first coupling member 157a may be located to be adjacent to one end of a third portion of the wire driving unit 153 (e.g., the first seating portion 153a in FIG. 8) in the y-axis direction. As an example, the first coupling member 157a may be located to be adjacent to one end of an opening (e.g., 1534 in FIG. 8) formed in a second portion (e.g., the accommodating portion 153d in FIG. 8) and the first seating portion 153a of the wire driving unit 153 in the y-axis direction. For example, the second coupling member 157b may be located to be adjacent to one end of the first portion of the wire driving unit 153 (e.g., the second seating portion 153b in FIG. 8) in the y-axis direction. As an example, the second coupling member 157b may be located to be adjacent to one end of an opening (e.g., 1532 in FIG. 8) formed in the second seating portion 153b of the wire driving unit 153 in the y-axis direction.

The first elastic member 156 may be formed to apply an elastic force (e.g., an elastic force in the -y-axis direction) to the wire 154 in the contracted state. For example, the first elastic member 156 may be formed to undergo elastic deformation (e.g., stretched) when the wire 154 is contracted. For example, one end (e.g., the end in the y-axis direction) of the first elastic member 156 may be coupled to the first magnetic body housing 151, and the other end (e.g., the end in the -y-axis direction) may be coupled to the wire driving unit 153. The one end of the first elastic member 156 may be pulled in the first direction in response to the movement of the first magnetic body housing 151 in the first direction (e.g., in the y-axis direction). The first elastic member 156 may be stretched in the first direction in proportion to the degree of contraction of the length of the wire 154 (e.g., the length in the y-axis direction). When the contraction of the wire 154 is completed (e.g., when the current supply to the wire 154 is cut off), the first elastic member 156 may be stretched to the maximum in the first direction. The one end of the stretched first elastic member 156 may be contracted in the second direction (e.g., in the -y-axis direction) opposite to the first direction. The first magnetic body housing 151 may be moved in the second direction together with one end of the first elastic member 156 by the elastic force of the first elastic member 156 (e.g., the elastic force in the -y-axis direction). At least a portion of the wire 154 (e.g., the other end 1543 coupled to the engaging portion 152b of the wire fixing portion 152a of the wire 154) may be extended in length with the movement of the first magnetic body housing 151 in the second direction. For example, after the first elastic member 156 is completely restored, the length of the wire 154 in the y-axis direction may be substantially the same as the length of the wire 154 in the y-axis direction in the contracted state (e.g., the first length L1 in FIG. 9).

As described above, the first elastic member 156 may be formed so that the operation of the first magnetic module 150 may be repeatedly performed. Using the restoring force of the first elastic member 156, the movement of the first magnetic body housing 151 in the first direction and the second direction may be repeatedly (or alternately) performed. The contracted and relaxed states of the wire 154 may be repeatedly (or alternately) implemented using the restoring force of the first elastic member 156. By the repetitive operation of the first magnetic module 150, the unfolding operation (e.g., unfolding from the second state to the first state) and the folding operation (e.g., folding from the first state to the second state) of the electronic device 100 may be repeatedly (or alternately) implemented.

For example, in the second state (e.g., the folded state) of the electronic device 100, the wire 154 and the first elastic member 156 may be maintained in their original, undeformed form. When current is applied to the wire 154 through the feeding unit 155, the wire 154 may contract, and the first magnetic body housing 151 coupled to at least a portion of the wire 154 may be moved in the first direction (e.g., in the y-axis direction). As the first magnetic body housing 151 is moved in the first direction, the attractive force acting between the first magnetic module 150 and the second magnetic module 160 may decrease, and the electronic device 100 may gradually unfold to the first state (e.g., the unfolded state) through the third state (e.g., the intermediate state). When the supply of current to the wire 154 through the feeding unit 155 is cut off, the first elastic member 156 stretched by the movement of the first magnetic body housing 151 may be restored while applying the elastic force to the first magnetic body housing 151 in the second direction (e.g., the -y-axis direction). The first magnetic body housing 151 may be moved in the second direction by the elastic force applied from the first elastic member 156, and the wire 154 may be stretched to its original shape without being deformed. The first magnetic body housing 151 may be moved in the second direction so that the attractive force may be acted again between the first magnetic module 150 and the second magnetic module 160. When the electronic device 100 is folded from the first state to the second state through the third state, the second state of the electronic device 100 may be maintained by the attractive force acting between the first magnetic module 150 and the second magnetic module 160. The wire 154 and the first elastic member 156 may be maintained in substantially the same shape as their original shape even after the above-described series of operations occur.

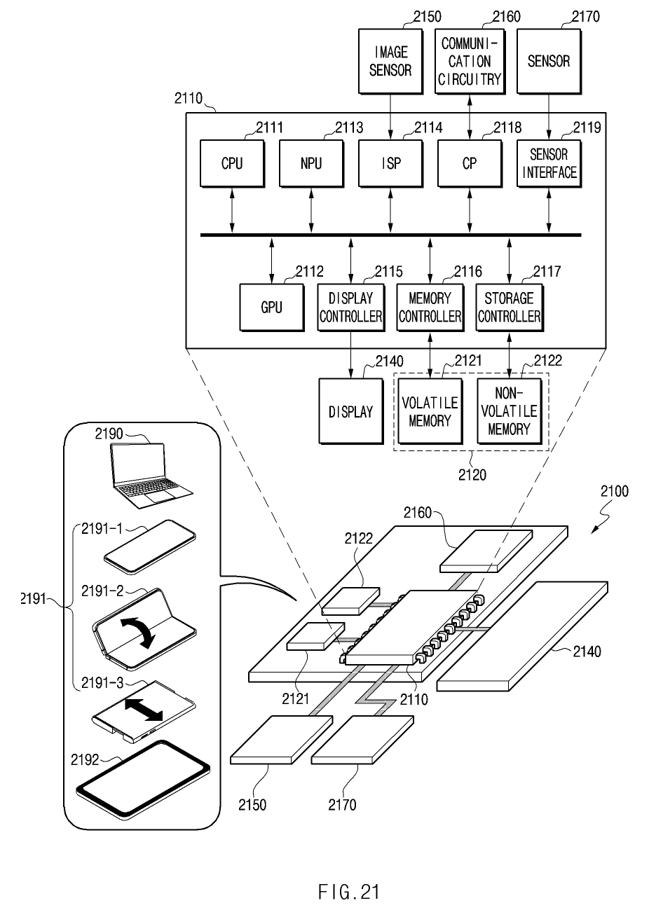

In an embodiment, the supply and cut-off of current to the wire 154 may occur when a specific operation of the user is input to the electronic device 100. For example, the current supply to the wire 154 may be adjusted as the operation of the user corresponding to the unfolding or folding operation of the electronic device 100 is input through a sensor of the electronic device 100 (e.g., a fingerprint sensor). For example, the operation of the user that induces the unfolding operation of the electronic device 100 may be an operation of contacting a part of a user’s body (e.g., a finger) with a first side member (e.g., the first side member 113 in FIG. 1A) or a second side member (e.g., the second side member 123 in FIG. 1A) of the electronic device 100 and applying a force of a certain level or greater. In an example, a processor (e.g., at least one processor 1910 in FIG. 21) included in the electronic device 100 may be configured to supply current to the wire 154 through the feeding unit 155 according to the operation recognized from the sensor.

FIG. 11 are perspective and side views illustrating an example of a coupled structure of the wire and the feeding unit according to an embodiment.

Reference number <1101> in FIG. 11 represents a form of a portion coupled to the feeding unit 155 of the wire 154. The remaining portion coupled to a wire housing (e.g., the wire housing 152 in FIG. 4) or a first magnetic body housing (e.g., the first magnetic body housing 151 in FIG. 4) of the wire 154 is omitted. Reference number <1102> represents a form of a portion coupled to the feeding unit 155 of the wire 154 as viewed from a different angle (e.g., in the -x-axis direction).

Referring to FIG. 11, in an embodiment, the feeding unit 155 may include a substrate 159 disposed on a wire driving unit (e.g., the wire driving unit 153 in FIG. 4) and a second elastic member 158 disposed on at least a portion of the substrate 159 and connected to the wire 154. The substrate 159 may be electrically connected to a printed circuit board disposed inside an electronic device (e.g., the electronic device 100 in FIG. 1A). The second elastic member 158 may be in contact with an electrode formed on the substrate 159. The second elastic member 158 may be formed of a conductive material, and an electrical path that connects the printed circuit board to the substrate 159, the second elastic member 158, and the wire 154 may be formed. Through the second elastic member 158, current may be supplied to the wire 154 to cause contraction of the wire 154.

The second elastic member 158 may include a portion coupled to the wire 154 and a portion coupled to the substrate 159. For example, the second elastic member 158 may include a second-first elastic member 1581 and a second-second elastic member 1582, respectively, coupled to a first wire 1541 and a second wire 1542 extended to be parallel to the y-axis of the wire 154. For example, the second-first elastic member 1581 may include a first portion 1581a that contacts the substrate 159 and a second portion (e.g., a first extension portion 1581b and a second extension portion 1581c) that is coupled to the first wire 1541. As an example, the second-first elastic member 1581 may have a first portion 1581a disposed on the substrate 159 (e.g., in the z-axis direction), and may be connected to an electrode of the substrate 159 to be electrically connected to the wire 154. The second elastic member 158 may form at least one coupling portion with the wire 154. For example, the second-first elastic member 1581 may include a second portion coupled to the first wire 1541. The second portion may include, for example, the first extension portion 1581b and the second extension portion 1581c that are coupled to different portions of the first wire 1541.

In an embodiment, the second elastic member 158 may be formed of a metal material or a plastic material. For example, the second elastic member 158 may be formed of stainless steel. In an example, the second elastic member 158 may be formed of gold-plated stainless steel. By gold-plating the second elastic member 158, a contact resistance between the second elastic member 158 and the wire 154 may be reduced, and galvanic corrosion may be prevented. In addition, the plating treatment of the second elastic member 158 may facilitate soldering of the second elastic member 158 and the substrate 159.

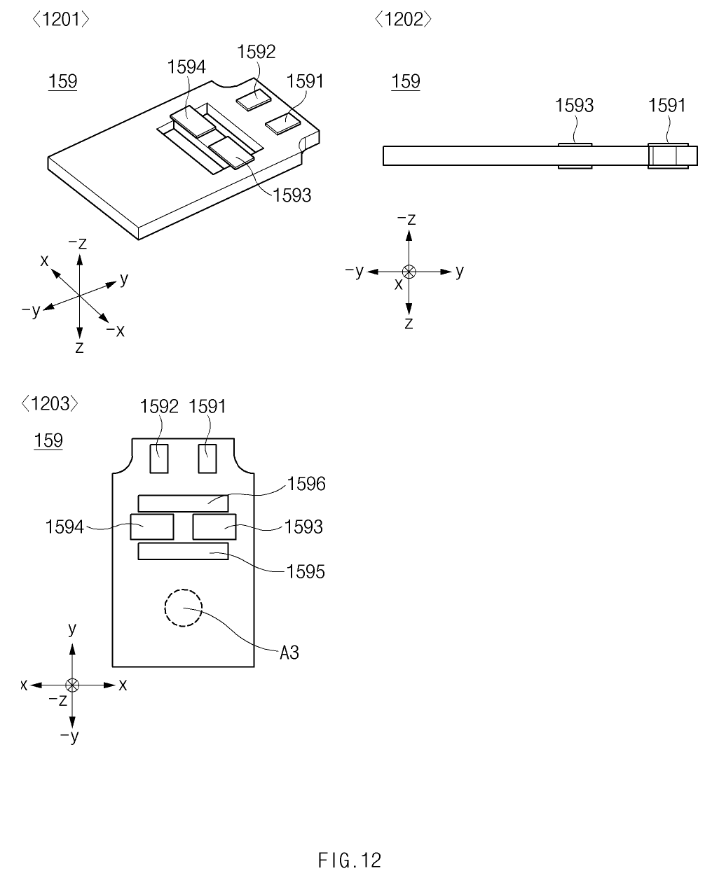

FIG. 12 are perspective, side and top-down views illustrating an example of a shape of a substrate of a feeding unit as viewed from various angles according to an embodiment.

FIG. 12 shows a shape of a substrate 159 of a feeding unit (e.g., the feeding unit 155 in FIG. 4). Reference number <1201> in FIG. 12 represents a form of the substrate 159 as viewed obliquely from the -z axis. Reference number <1202> represents a form of the substrate 159 as viewed from the -x axis, and reference number <1203> represents a form of the substrate 159 as viewed from the z axis.

Referring to FIG. 12, in an embodiment, the feeding unit 155 may include a substrate 159 electrically connected to a printed circuit board of an electronic device (e.g., the electronic device 100 in FIG. 1A). The substrate 159 may include at least one electrode electrically connected to the printed circuit board. For example, the substrate 159 may include first electrodes 1591 and 1592 connected to the printed circuit board. The substrate 159 may include at least one electrode electrically connected to a second elastic member (e.g., the second elastic member 158 in FIG. 11). For example, the substrate 159 may include second electrodes 1593 and 1594 that are in contact with a second-first elastic member (e.g., the second-first elastic member 1581 in FIG. 11) and a second-second elastic member (e.g., the second-second elastic member 1582 in FIG. 11), respectively.

As an example, the substrate 159 may include the first electrodes 1591 and 1592 that supply current to the substrate 159 from another electrical component (e.g., the printed circuit board) within the electronic device 100 and the second electrodes 1593 and 1594 that supply current to a wire (e.g., the wire 154 in FIG. 4) through the second elastic member 158. The first electrodes 1591 and 1592 and the second electrodes 1593 and 1594 may be spaced apart from each other. For example, the first electrodes 1591 and 1592 may be spaced apart from the second electrodes 1593 and 1594 in the y-axis direction. Each of the first electrodes 1591 and 1592 may be spaced apart from the other in the x-axis direction, and each of the second electrodes 1593 and 1594 may be spaced apart from the other in the x-axis direction. In an embodiment, the first electrodes 1591 and 1592 and the second electrodes 1593 and 1594 may be formed to have different polarities. For example, when the first electrodes 1591 and 1592 are formed as a + polarity (e.g., an anode), the second electrodes 1593 and 1594 may be formed as a - polarity (e.g., a cathode).

In an embodiment, the second electrodes 1593 and 1594 may be formed to be extended from a surface of the substrate 159 contacting the wire driving unit 153 (e.g., a surface facing the -z axis) to a surface opposite to the surface (e.g., a surface facing the z axis). For example, at least a portion of the second electrodes 1593 and 1594 may be formed to protrude from the surface of the substrate 159 facing the z-axis or to be formed parallel to the surface. The portion of the second electrodes 1593 and 1594 exposed toward the z-axis (e.g., visible on the substrate 159) may be in contact with, or at least partially coupled to, a first portion of the second elastic member 158 (e.g., the first portion 1581a in FIG. 11). An electrical path connecting the printed circuit board, the electrodes 1591, 1592, 1593, and 1594, the second elastic member 158, and the wire 154 may be formed through physical connection and/or electrical connection of the substrate 159 and the second elastic member 158 at the first portion 1581a.

An opening may be formed in the substrate 159 to which the second elastic member 158 may be coupled. For example, in the substrate 159, a first opening 1595 may be formed in the -y-axis direction and a second opening 1596 may be formed in the y-axis direction with respect to the second electrodes 1593 and 1594. The first opening 1595 and the second opening 1596 may be formed to be able to be coupled to at least a portion of the second elastic member 158. For example, the first opening 1595 may be formed to have a y-axis direction width that is substantially the same as a y-axis direction width of a first extension portion of the second-first elastic member 1581 (e.g., the first extension portion 1581b in FIG. 11). The second opening 1596 may be formed to have a y-axis direction width that is substantially the same as a y-axis direction width of the second extension portion of the second-first elastic member 1581 (e.g., the second extension portion 1581c in FIG. 11). The first opening 1595 and/or the second opening 1596 may be coupled to the second-first elastic member 1581 and a second-second elastic member (e.g., the second-second elastic member 1582 in FIG. 11).

The substrate 159 may include a region A3 for appropriately disposing the substrate 159 during the coupling process of components of a first magnetic module (e.g., the first magnetic module 150 in FIG. 4). For example, the region A3 may correspond to a region to be absorbed by an external tool so that the substrate 159 may come into contact with a wire driving unit (e.g., the wire driving unit 153 in FIG. 4) or the second elastic member 158. The region A3 may be, for example, any region located further in the -y-axis direction than the first opening 1595 on the substrate 159. The region A3 may be, for example, a circular shape having a diameter of 0.5 mm.

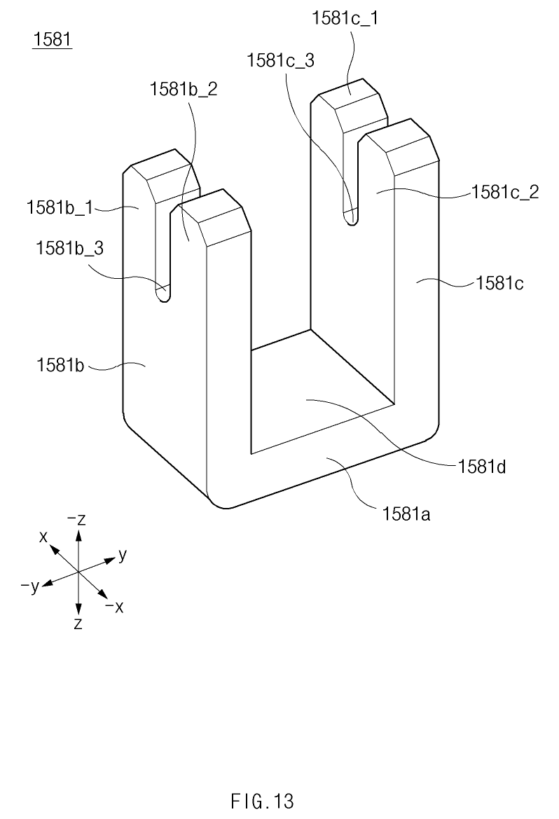

FIG. 13 is a perspective view illustrating an example of a shape of a second elastic member according to an embodiment.

Referring to FIGS. 11 to 13, in an embodiment, a second elastic member (e.g., the second elastic member 158 in FIG. 11) may include a first portion (e.g., a portion extended to be parallel to the y-axis) that contacts an electrode (e.g., the second electrodes 1593 and 1594 in FIG. 12) of a substrate (e.g., the substrate 159 in FIG. 12) and a second portion extended from the first portion and coupled to a wire (e.g., the wire 154 in FIG. 4). For example, the second-first elastic member 1581 may include a first portion 1581a that contacts the second electrode 1593 of the substrate 159 and a second portion (e.g., a first extension portion 1581b and a second extension portion 1581c) that is extended from the first portion 1581a and coupled to a first wire (e.g., the first wire 1541 in FIG. 11). One surface 1581d of the first portion 1581a facing the -z axis may be in contact with the second electrode 1593 of the substrate 159, and the second-first elastic member 1581 and the substrate 159 may be electrically connected. As an example, an adhesive material (e.g., a conductive adhesive or a conductive epoxy) may be applied to the one surface 1581d and/or the second electrode 1593. Alternatively, in an embodiment, the one surface 1581d and the second electrode 1593 may be soldered so that the second-first elastic member 1581 and the substrate 159 are electrically connected.

The second-first elastic member 1581 may include a first extension portion 1581b extended to be perpendicular (e.g., in the -z-axis direction) to the first portion 1581a from one end (e.g., an end in the -y-axis direction) of the first portion 1581a, and the second extension portion 1581c extended to be perpendicular (e.g., in the -z-axis direction) to the first portion 1581a from the other end (e.g., an end in the y-axis direction) of the first portion 1581a. The first extension portion 1581b may be extended to pass through a first opening of the substrate 159 (e.g., the first opening 1595 in FIG. 12). The second extension portion 1581c may be extended to pass through a second opening of the substrate 159 (e.g., the second opening 1596 in FIG. 12).

Recesses 1581b_3 and 1581c_3 through which the wire 154 passes may be formed in the first extension portion 1581b and the second extension portion 1581c. For example, the first extension portion 1581b may include a first-first extension portion 1581b_1 and a first-second extension portion 1581b_2, which are extended in the -z-axis direction, and a first recess 1581b_3 formed between the first-first extension portion 1581b_1 and the first-second extension portion 1581b_2. For example, the second extension portion 1581c may include a second-first extension portion 1581c_1 and a second-second extension portion 1581c_2, which are extended in the -z-axis direction, and a second recess 1581c_3 formed between the second-first extension portion 1581c_1 and the second-second extension portion 1581c_2

At least a portion of the wire (e.g., the first wire 1541 in FIG. 11) may be surrounded by a second portion of the second elastic member 158 (e.g., the first extension portion 1581b and the second extension portion 1581c). For example, at least a portion adjacent to one end (e.g., an end in the y-axis direction) of the first wire 1541 may be surrounded by the first-first extension portion 1581b_1, the first-second extension portion 1581b_2, and the first recess 1581b_3 of the first extension portion 1581b. At least a portion between the one end of the first wire 1541 and the portion surrounded by the first extension portion 1581b may be surrounded by a second-first extension portion 1581c_1, a second-second extension portion 1581c_2, and a second recess 1581c_3 of the second extension portion 1581c. As an example, the first wire 1541 may be disposed in a space (e.g., a space in the -z-axis direction) in the first recess 1581b_3 and the second recess 1581c_3. Alternatively, as an example, the first wire 1541 may be seated in the first recess 1581b_3 and the second recess 1581c_3.

In various embodiments, a second-second elastic member (e.g., the second-second elastic member 1582 in FIG. 11) may be formed in substantially the same shape as the second-first elastic member 1581. For example, the second-second elastic member 1582 may include a first portion that contacts the electrode 1594 of the substrate 159 and a second portion vertically extended from the first portion. A second portion of the second-second elastic member 1582 may pass through the openings 1595 and 1596 of the substrate 159 and may be coupled to a second wire (e.g., the second wire 1542 in FIG. 11).

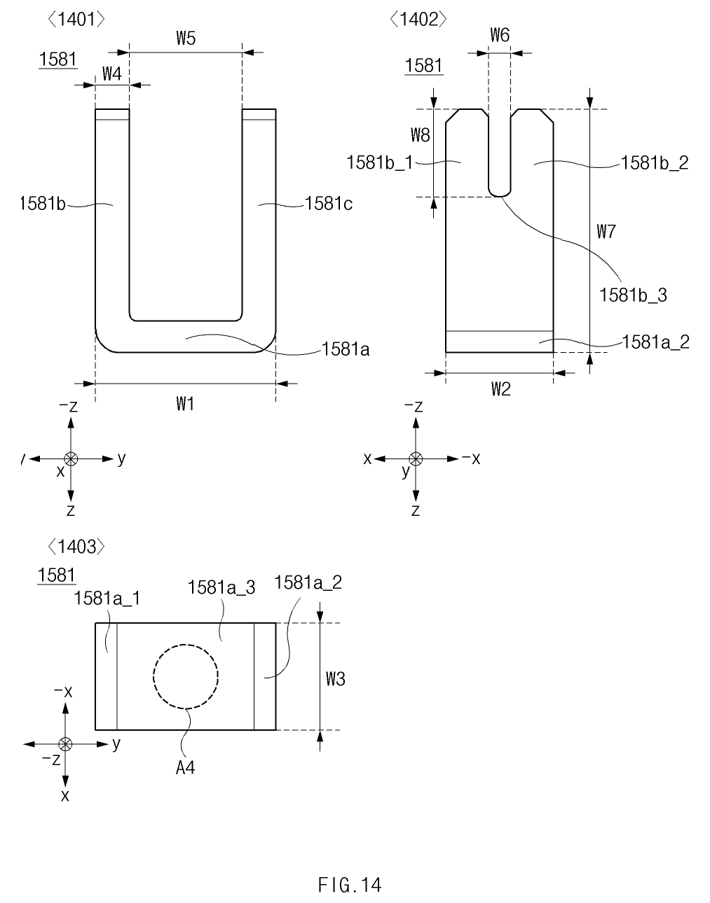

FIG. 14 are views illustrating a shape of the second elastic member in FIG. 13 as viewed from various angles.

Reference number <1401> in FIG. 14 represents a form of the second-first elastic member 1581 as viewed from the -x axis. Reference number <1402> represents a form of the second-first elastic member 1581 as viewed from the -y axis. Reference number <1403> represents a form of the second-first elastic member 1581 as viewed from the z-axis direction.

Referring to FIG. 14, in an embodiment, a first width W1 of the first portion 1581a of the second-first elastic member 1581 in the y-axis direction may be formed to be longer than a second width W2 in the x-axis direction. For example, the second width W2 of the first portion 1581a may be formed to be 0.95 mm, and the first width W1 may be formed to be 1.6 mm, which is larger than the second width W2. The width of the first extension portion 1581b of the second-first elastic member 1581 in the x-axis direction may be formed to be the same as the second width W2 of the first portion 1581a in the x-axis direction. A third width W3 of the second extension portion 1581c of the second-first elastic member 1581 in the x-axis direction may be formed to be the same as the width (e.g., W2) of the first extension portion 1581b in the x-axis direction. For example, the third width W3 may be formed to be 0.95 mm. The widths of the first extension portion 1581b and the second extension portion 1581c in the y-axis direction may be formed to be substantially the same. For example, a fourth width W4 of the first extension portion 1581b in the y-axis direction and the width of the second extension portion 1581c in the y-axis direction may be formed to have the same width (e.g., 0.3 mm). As an example, the fourth width W4 may be formed to be smaller than the first width W1. The separation of the first extension portion 1581b and the second extension portion 1581c in the y-axis direction may be formed to have a fifth width W5 that is wider than the fourth width W4. A gap (e.g., a gap in the x-axis direction) between the first-first extension portion 1581b_1 and the first-second extension portion 1581b_2 of the second elastic member 1581 may be formed to be smaller than the width of the first-first extension portion 1581b_1 and a first-second extension portion 1591b_2 in the x-axis direction. For example, a sixth width W6 between the first-first extension portion 1581b_1 and the first-second extension portion 1581b_2 may be formed to be 0.15 mm. Alternatively, for example, the width of the first recess 1581b_3 of the second elastic member 1581 in the x-axis direction may be formed to be smaller (e.g., 0.15 mm) than the widths of the first-first extension portion 1581b_1 and the first-second extension portion 1591b_2 in the x-axis direction. A seventh width W7 of the first extension portion 1581b in the z-axis direction may be formed to be larger than the first width W1 of the first portion 1581a in the y-axis direction. For example, the seventh width W7 may be formed to be 2.15 mm.

In an embodiment, the second-first elastic member 1581 may include a curved portion formed in the first portion 1581a, the first extension portion 1581b, or the second extension portion 1581c. For example, a first curved portion 1581a_1 may be formed at a boundary between the first portion 1581a and the first extension portion 1581b (e.g., a portion extended from the first portion 1581a of the first extension portion 1581b in the -z-axis direction). For example, a second curved portion 1581a_2 may be formed at a boundary between the first portion 1581a and the second extension portion 1581c (e.g., a portion extended from the first portion 1581a of the second extension portion 1581c in the -z-axis direction). The first portion 1581a may include a first curved portion 1581a_1, the second curved portion 1581a_2, and a flat portion 1581a_3 formed between the first curved portion 1581a_1 and the second curved portion 1581a_2.

The second elastic member (e.g., the second elastic member 158 in FIG. 11) may include a region A4 for appropriately disposing the second elastic member 158 during a process of coupling components of a first magnetic module (e.g., the first magnetic module 150 in FIG. 4). For example, the region A4 may correspond to a region to be absorbed by an external tool so that the second-first elastic member 1581 may come into contact with a substrate (e.g., the substrate 159 in FIG. 12). The region A4 may be, for example, an arbitrary region (e.g., a portion of the flat portion 1581a_3) located in the first portion 1581a of the second-first elastic member 1581. The region A4 may be, for example, a circular shape having a diameter of 0.5 mm.

In an embodiment, the sixth width W6 of the first recess 1581b_3 in the x-axis direction and an eighth width W8 of the first-first extension portion 1581b_1 and the first-second extension portion 1581b_2 in the z-axis direction may be formed by considering the diameter of the wire (e.g., the first wire 1541 in FIG. 11). For example, the sixth width W6 may be formed to be substantially the same as or slightly smaller than the diameter of the first wire 1541 in order to be firmly fixed (or fastened) to the first wire 1541. For example, the eighth width W8 may be formed to be several times (e.g., two to three times) or more than the diameter of the first wire 1541 so that the first wire 1541 is not separated from the first recess 1581b_3 (or from the second-first elastic member 1581). In an example, the sixth width W6 and the eighth width W8 may be set to be stably fixed (or fastened) to the first wire 1541 in a contracted state by considering the change in diameter (e.g., a decrease in diameter cut in the x-axis direction due to increase in length in the y-axis direction) when the first wire 1541 is contracted.

In an embodiment, the shape and size of the first magnetic module (e.g., the first magnetic module 150 in FIG. 4) and the second magnetic module (e.g., the second magnetic module 160 in FIG. 4) may be designed to reduce an occupancy rate of a mounting space inside the electronic device 100 by considering the characteristics of the foldable electronic device (e.g., the electronic device 100 in FIG. 1A). For example, the diameter of the wire (e.g., the wire 154 in FIG. 4), the lengths of each portion of the second elastic member (e.g., the second elastic member 158 in FIG. 11) in the x, y, and z-axis directions (e.g., the first width W1 to the eighth width W8 of the second-first elastic member 1581), or the overall length of the first magnetic module 150 (e.g., the length in the y-axis direction) may be formed to be smaller than other types of electronic devices (e.g., a laptop computer 1990 in FIG. 21) by considering the overall size of the foldable electronic device 100 (e.g., a foldable type smartphone 1991-2 in FIG. 21). As an example, referring to FIG. 4, at least some of the components included in the first magnetic module 150 (e.g., the first magnetic body housing 151, the wire housing 152, the wire driving unit 153, the wire 154, the feeding unit 155, the first elastic member 156, or the fastening member 157) may be disposed side by side along the y-axis, thereby miniaturizing the first magnetic module 150.

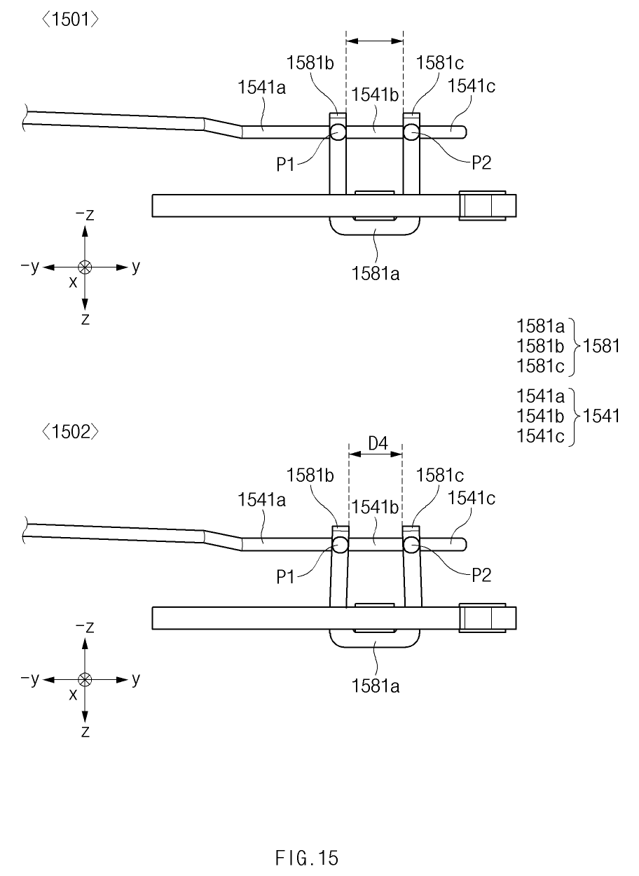

FIG. 15 are side views illustrating an example of a form in which a wire and an elastic member are deformed according to an embodiment.

Reference number <1501> in FIG. 15 represents a coupled form of the first wire 1541 and the second-first elastic member 1581 in a relaxed state of the first wire 1541. Reference number <1502> represents a coupled form of the first wire 1541 and the second-first elastic member 1581 in a contracted state of the first wire 1541.

Referring to FIGS. 11 to 15, in an embodiment, a wire (e.g., the wire 154 in FIG. 4) and a second elastic member (e.g., the second elastic member 158 in FIG. 11) may be coupled to each other via an adhesive material (or an adhesive member). For example, the adhesive material may be formed from a thermosetting resin (e.g., an epoxy-based adhesive). As an example, the first wire 1541 may be coupled to the first extension portion 1581b and the second extension portion 1581c of the second-first elastic member 1581 using the adhesive material. For example, a first coupling portion P1 (or a first fixed point) may be formed from a portion located on (e.g., on the -z axis) a first recess (e.g., the first recess 1581b_3 in FIG. 13) of the first wire 1541, a portion of the first extension portion 1581b, and the adhesive material. For example, a second coupling portion P2 (or a second fixed point) may be formed from a portion located on (e.g., on the -z axis) a second recess (e.g., the second recess 1581c_3 in FIG. 13) of the first wire 1541, a portion of the second extension portion 1581c, and the adhesive material.

Alternatively, in an embodiment, the wire 154 may be seated on (e.g., on the -z-axis) the first recess 1581b_3 or the second recess 1581c_3 to be coupled to the first recess 1581b_3 or the second recess 1581c_3. For example, the first coupling portion P1 may be formed from a portion of the wire 154 adjacent to the first recess 1581b_3, the first recess 1581b_3, and the adhesive material applied between the first recess 1581b_3 and the portion of the wire 154. For example, the second coupling portion P2 may be formed from another portion of the wire 154 adjacent to the second recess 1581c_3, the second recess 1581c_3, and the adhesive material applied between the other portion of the wire 154 and the second recess 1581c_3.

The first coupling portion P1 may be formed by applying the adhesive material between the first wire 1541 and the first extension portion 1581b and then curing the adhesive material. The second coupling portion P2 may be formed by applying the adhesive material between the first wire 1541 and the second extension portion 1581c and then curing the adhesive material. Even after the first coupling portion P1 and the second coupling portion P2 are formed, the cured adhesive material may be deformed or removed through heating, and an operation of re-forming the coupling portion of the first wire 1541 and the second elastic member 1581 may be performed. The first wire 1541 may include a first region 1541a from one end coupled to a first magnetic body housing (e.g., the first magnetic body housing 151 in FIG. 4) to the first coupling portion P1, a second region 1541b from the first coupling portion P1 to the second coupling portion P2, and a third region 1541c from the second coupling portion P2 to the other end opposite the one end.

Referring to reference number <1501>, in a relaxed state where no current flows through the wire 154, the first coupling portion P1 and the second coupling portion P2 may be formed to be spaced apart from each other by a third distance D3 in the y-axis direction. For example, in the relaxed state of the wire 154, one end (e.g., the end in the -z-axis direction) of the first extension portion 1581b constituting the first coupling portion P1 and one end (e.g., the end in the -z-axis direction) of the second extension portion 1581c constituting the second coupling portion P2 may be spaced apart from each other by a third distance D3 in the y-axis direction. For example, in the relaxed state, the second region 1541b of the first wire 1541 may be formed at the third distance D3.

Referring to reference number <1502>, in a contracted state where current flows through the wire 154, the first coupling portion P1 and the second coupling portion P2 may be spaced apart from each other by a fourth distance D4, which is smaller than the third distance D3, in the y-axis direction. For example, in the contracted state of the wire 154, one end (e.g., the end in the -z-axis direction) of the first extension portion 1581b constituting the first coupling portion P1 and one end (e.g., the end in the -z-axis direction) of the second extension portion 1581c constituting the second coupling portion P2 may be spaced apart from each other by the fourth distance D4, which is smaller than the third distance D3, in the y-axis direction. For example, in the contracted state, the second region 1541b of the first wire 1541 may be formed to have the fourth distance D4.

In an embodiment, the second elastic member 158 may be formed to be deformed in a direction corresponding to the deformation of the wire 154. For example, at least a portion of the first extension portion 1581b and at least a portion of the second extension portion 1581c may be deformed so that the second-first elastic member 1581 may be deformed in the same direction as the contraction direction and/or relaxation direction of the first wire 1541. For example, in the contracted state, lengths (e.g., the lengths in the y-axis direction) of the first region 1541a, the second region 1541b, and the third region 1541c of the wire 1541 may be reduced. Corresponding to the reduced second region 1541b, the first extension portion 1581b may be deformed so that at least a portion (e.g., a portion adjacent to the first coupling portion P1 of the first extension portion 1581b) is moved in the y-axis direction. In addition, the second extension portion 1581c may be deformed so that at least a portion (e.g., a portion adjacent to the second coupling portion P2 of the second extension portion 1581c) is moved in the -y-axis direction. Alternatively, for example, the first extension portion 1581b may be deformed so that at least a portion (e.g., a portion adjacent to the first coupling portion P1 of the first extension portion 1581b) is moved in the y-axis direction in response to the length contraction of the first region 1541a in the y-axis direction, and the second extension portion 1581c may be deformed so that at least a portion (e.g., a portion adjacent to the second coupling portion P2 of the second extension portion 1581c) is moved in the -y-axis direction in response to the length contraction of the third region 1541c in the -y-axis direction.

As an example, an angle formed by the first extension portion 1581b and the first portion 1581a and an angle formed by the second extension portion 1581c and the first portion 1581a may be reduced in the contracted state compared to the relaxed state. For example, the first extension portion 1581b and the first portion 1581a may be formed to form a first angle in the relaxed state, and may be deformed to form a second angle, which is smaller than the first angle, in the contracted state. For example, a portion adjacent to the first portion 1581a of the first extension portion 1581b and a portion adjacent to the first portion 1581a of the second extension portion 1581c may be bent so that a portion constituting the first coupling portion P1 of the first extension portion 1581b and a portion constituting the second coupling portion P2 of the second extension portion 1581c are moved along a length-reducing direction of the second region 1541b of the first wire 1541.

In an embodiment, the first extension portion 1581b and the second extension portion 1581c may be deformed corresponding to a stretched direction of the first wire 1541 as the current supply to the first wire 1541 is cut off and the first wire 1541 is stretched by a first elastic member (e.g., the first elastic member 156 in FIG. 4). For example, at least a portion of the first extension portion 1581b (e.g., the portion adjacent to the first portion 1581a of the first extension portion 1581b) and at least a portion of the second extension portion 1581c (e.g., the portion adjacent to the first portion 1581a of the second extension portion 1581c) may be bent so that the portion constituting the first coupling portion P1 of the first extension portion 1581b and the portion constituting the second coupling portion P2 of the second extension portion 1581c are moved away from each other. Through the bending of the first extension portion 1581b and the second extension portion 1581c, the distance between the first coupling portion P1 and the second coupling portion P2 may be restored from the fourth distance D4 to the third distance D3.

As described above, the portion where the second elastic member 158 and the wire 154 are fixed (e.g., the first coupling portion P1 and the second coupling portion P2) may be moved along contraction and relaxation directions of the wire 154, and a stress applied to the wire 154 during the contraction and relaxation process of the wire 154 may be reduced. For example, the first wire 1541 may be contracted and relaxed around the first coupling portion P1 and the second coupling portion P2. In this process, the first extension portion 1581b and the second extension portion 1581c of the second-first elastic member 1581 may be elastically deformed, so that excessive stress (e.g., a frictional force or a tensile force) may not be acted to portions of the first wire 1541 constituting the first coupling portion P1 and the second coupling portion P2. The occurrence of defects due to repetitive operations of the wire 154 (e.g., contraction of the wire 154 during the unfolding operation of the electronic device 100 in FIG. 1A and relaxation of the wire 154 during the folding operation of the electronic device 100) may be reduced by elastic deformation of the second elastic member 158. In addition, fatigue destruction (e.g., wire breakage) of the wire 154 may be prevented by elastic deformation of the second elastic member 158, and the lifespan of the wire 154 and the lifespan of a first magnetic module (e.g., the first magnetic module 150 in FIG. 4) including the wire 154 may be increased.

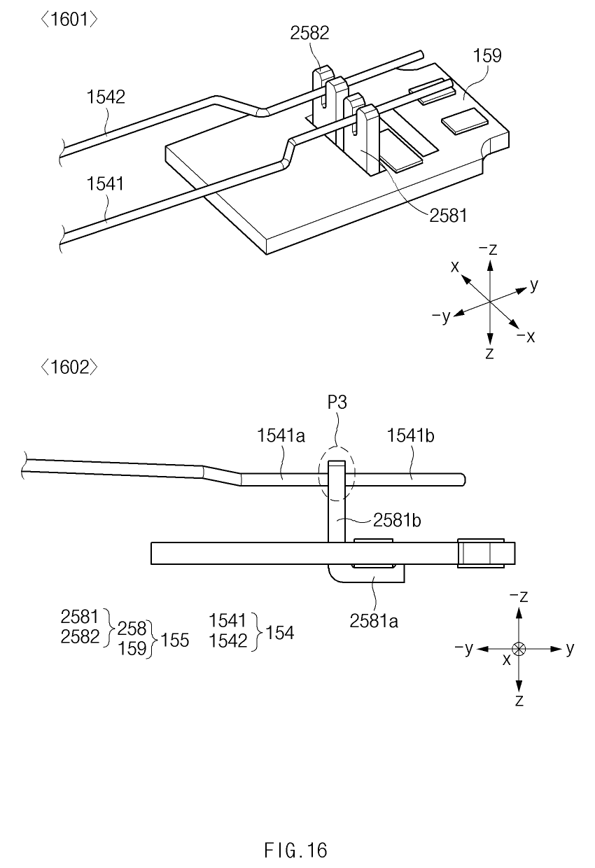

FIG. 16 are perspective and side views illustrating an example of a coupled structure of a wire and a feeding unit according to an embodiment.

Reference numbers <1601> and <1602> in FIG. 16 represent a form in which a second elastic member (e.g., the second elastic member 158 in FIG. 11) of a first magnetic module (e.g., the first magnetic module 150 in FIG. 4) is deformed. For example, a second elastic member 258 in FIG. 16 may be in a form of the second elastic member 158 in FIG. 11 in which a second extension portion (e.g., the second extension portion 1581c in FIG. 11) and a second curved portion (e.g., the second curved portion 1581a_2 in FIG. 14) of the first portion 1581a are removed.

Referring to FIG. 16, in an embodiment, the feeding unit 155 of the first magnetic module 150 may include the second elastic member 258 coupled to the substrate 159 and the wire 154. For example, the second elastic member 258 may include a second-first elastic member 2581 coupled to the first wire 1541 and a second-second elastic member 2582 coupled to the second wire 1542. As an example, the second-first elastic member 2581 may include a first portion 2581a that contacts an electrode of the substrate 159 and a second portion 2581b that is extended from the first portion 2581a in the -z-axis direction. The second portion 2581b may be coupled to the first wire 1541. For example, at least a portion of the second portion 2581b may be coupled to the first wire 1541 through an adhesive material (e.g., a thermosetting resin). A third coupling portion P3 may be formed from the second portion 2581b, the first wire 1541, and the adhesive material. With respect to the third coupling portion P3, the first wire 1541 may be divided into the first region 1541a (or first wire) in the -y-axis direction and the second region 1541b (or second wire) in the y-axis direction. The second-first elastic member 2581 may be elastically deformed so that the third coupling portion P3 may be moved in a direction corresponding to the contraction and relaxation of the first wire 1541. For example, the second portion 2581b may be bent so that at least a portion of the second portion 2581b constituting the third coupling portion P3 may be moved in the same direction as the contraction direction and relaxation direction of the first wire 1541. Through elastic deformation of the second elastic member 258, the stress applied to the wire 154 may be minimized, and the lifespan of the wire 154 may be increased. Regarding the detailed structure and function of the second elastic member 258, the description provided for the second elastic member 158 in FIGS. 8 to 15 may be substantially identically referred to.

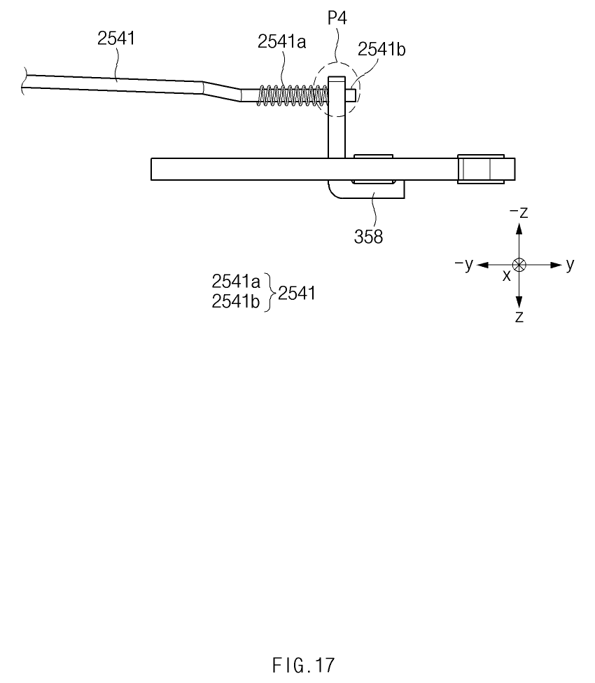

FIG. 17 is a side view illustrating an example of a coupled structure of a wire and a feeding unit according to an embodiment.

FIG. 17 shows a form in which a wire (e.g., the wire 154 in FIG. 4) and a second elastic member (e.g., the second elastic member 258 in FIG. 16) of a first magnetic module (e.g., the first magnetic module 150 in FIG. 4) are deformed. A fixing member 358 in FIG. 17 may be formed to be substantially the same as, for example, the shape of the second elastic member 258 in the undeformed state in FIG. 16.

Referring to FIG. 17, in an embodiment, the first magnetic module 150 may include a first wire 2541 and the fixing member 358. The first wire 2541 may be coupled to at least a portion of the fixing member 358 using an adhesive material. A fourth coupling portion P4 may be formed from the first wire 2541, the fixing member 358, and the adhesive material. The first wire 2541 may include a first region 2541a (or a first wire) in the -y-axis direction and a second region 2541b (or a second wire) in the y-axis direction based on the fourth coupling portion P4.

In an embodiment, a portion adjacent to the fourth coupling portion P4 of the first wire 2541 may be formed to be deformable in response to contraction and relaxation of the first wire 2541. For example, the first region 2541a of the first wire 2541 may be formed in an elastically deformable shape (e.g., a spring) to be able to be moved in the same directions as the contraction and relaxation directions of the first wire 2541. In an example, by elastically deforming the first region 2541a of the first wire 2541, the fixing member 358 may be maintained in the same shape regardless of the contraction and relaxation of the first wire 2541. The stress applied to the first wire 2541 may be minimized by deformation of the first region 2541a, and the lifespan of the first wire 2541 may be increased. That is, due to the presence of the first region 2541a, the fixing member 358 may be formed of a material that does not elastically deform, unlike the second elastic members 158 and 258 in FIGS. 11 to 16.

Alternatively, in an embodiment, the first wire 2541 may be connected to a separate elastic member that is deformed in response to contraction and relaxation of the first wire 2541. For example, an elastic member (e.g., a spring) may be disposed in the first region 2541a of the first wire 2541, and a portion forming the fourth coupling portion P4 of the first wire 2541 may be coupled to the elastic member. The elastic member may be contracted and relaxed in the same directions as the contraction direction and relaxation direction of the first wire 2541. The stress applied to the first wire 2541 by the elastic member may be minimized, and the lifespan of the first wire 2541 may be increased. That is, due to the presence of the elastic member, the fixing member 358 may be formed of a material that is not elastically deformed, unlike the second elastic members 158 and 258 of FIGS. 11 to 16.

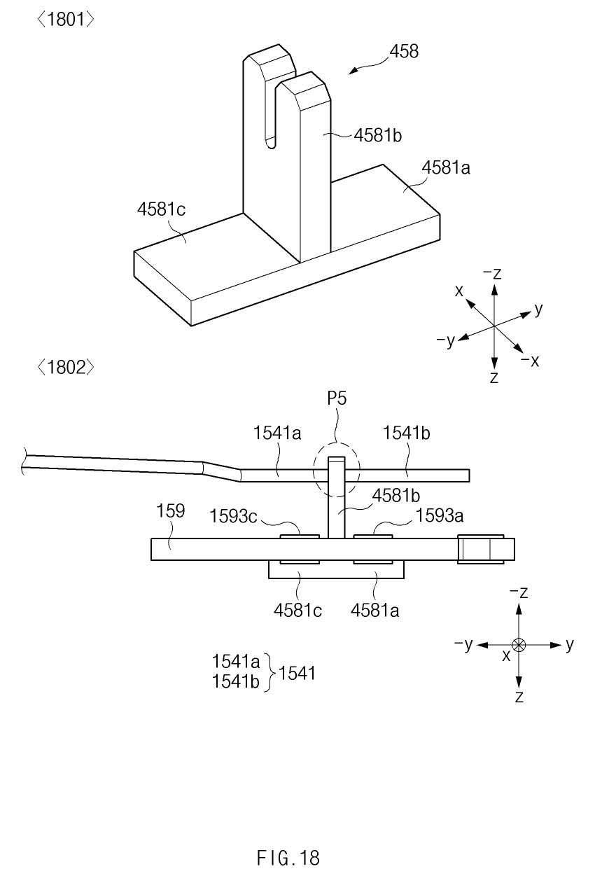

FIG. 18 are perspective and side views illustrating an example of a coupled structure of a wire and a feeding unit according to an embodiment.

Reference numbers <1801> and <1802> in FIG. 18 represent a form in which a second elastic member (e.g., the second elastic member 158 in FIG. 11) of a first magnetic module (e.g., the first magnetic module 150 in FIG. 4) is deformed. For example, a second elastic member 458 in FIG. 18 may be in a form in which the first portion 2581a of the second elastic member 258 in FIG. 16 is further extended to the left (e.g., in the -y-axis direction) of the second portion 2581b. For example, the second elastic member 458 in FIG. 18 may be formed to be similar to a shape in which the letter T is inverted.

Referring to FIG. 18, in an embodiment, a feeding unit (e.g., the feeding unit 155 in FIG. 4) of the first magnetic module 150 may include the second elastic member 458 coupled to the substrate 159 and a wire (e.g., the wire 154 in FIG. 4). For example, the second elastic member 458 may include first portions 4581a and 4581c that contact the electrode of the substrate 159 and a second portion 4581b that is extended from the first portions 4581a and 4581c in the -z-axis direction. The second portion 4581b may be coupled to the first wire 1541. The first portions 4581a and 4581c may include a portion 4581a extended to one side (e.g., in the y-axis direction) and a portion 4581c extended to the other side (e.g., in the -y-axis direction) with respect to the second portion 4581b. The first portions 4581a and 4581c may be extended to both sides with respect to the second portion 4581b so as to come into contact with the second electrodes 1593a and 1593c disposed on the substrate 159, respectively. For example, the second elastic member 458 may be formed so that an area coming into contact with the substrate 159 is increased, and may be stably fastened to the substrate 159.

At least a portion of the second portion 4581b may be coupled to the first wire 1541 through an adhesive material (e.g., a thermosetting resin). A fifth coupling portion P5 may be formed from the second portion 4581b, the first wire 1541, and the adhesive material. With respect to the fifth coupling portion P5, the first wire 1541 may be divided into the first region 1541a (or first wire) in the -y-axis direction and the second region 1541b (or second wire) in the y-axis direction. The second elastic member 458 may be elastically deformed so that the fifth coupling portion P5 may be moved in a direction corresponding to the contraction and relaxation of the first wire 1541. For example, the second portion 4581b may be bent so that at least a portion of the second portion 4581b constituting the fifth coupling portion P5 may be moved in the same direction as the contraction direction and relaxation direction of the first wire 1541. Through elastic deformation of the second elastic member 458, the stress applied to the wire 154 may be minimized, and the lifespan of the wire 154 may be increased. Regarding the detailed structure and function of the second elastic member 458, the description provided for the second elastic member 158 in FIGS. 8 to 15 may be substantially identically referred to.

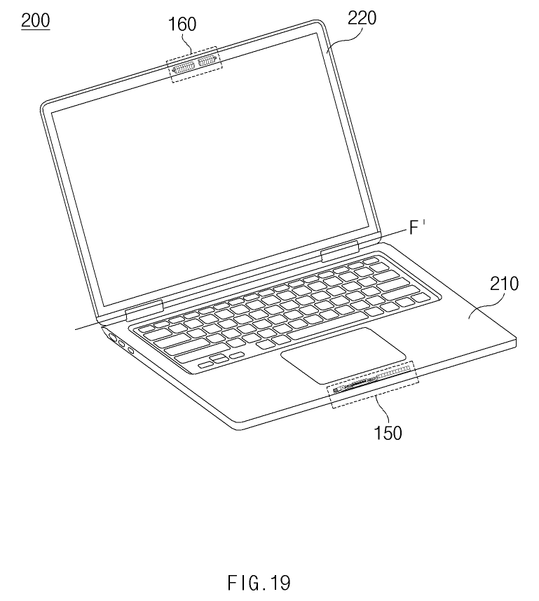

FIG. 19 is a perspective view illustrating an example of a form in which a first magnetic module and a second magnetic module are applied to an electronic device according to an embodiment.

FIG. 19 shows a form in which a first magnetic module (e.g., the first magnetic module 150 in FIG. 4) and a second magnetic module (e.g., the second magnetic module 160 in FIG. 4) are applied to an electronic device 200 (e.g., a laptop computer) that may be folded and unfolded about a folding axis F’.

Referring to FIG. 19, in an embodiment, the electronic device 200 may include a first housing 210, a second housing 220, the first magnetic module 150 disposed in the first housing 210, and the second magnetic module 160 disposed in the second housing 220. For example, the first magnetic module 150 may be disposed at an edge formed furthest from the folding axis F’ of the first housing 210. The second magnetic module 160 may be disposed at an edge formed furthest from the folding axis F’ of the second housing 220. The first magnetic module 150 and the second magnetic module 160 may be formed to exert an attractive force on each other so that a folded state of the electronic device 200 may be maintained. At least one of the first magnetic module 150 or the second magnetic module 160 may include a deformable shape memory alloy member (e.g., the wire 154 in FIG. 4) so that the electronic device 200 may be easily unfolded.

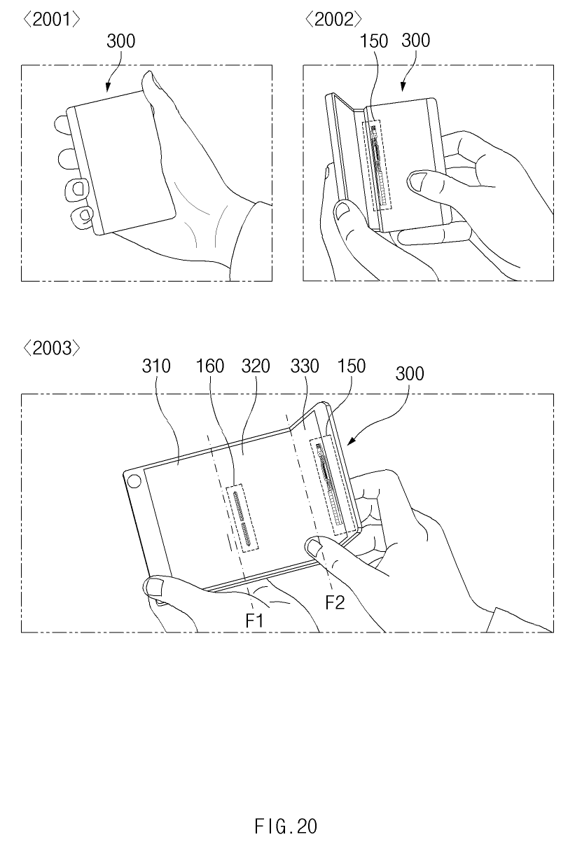

FIG. 20 are views illustrating an example of a form in which a first magnetic module and a second magnetic module according to an embodiment are applied to an electronic device.

FIG. 20 shows a form in which a first magnetic module (e.g., the first magnetic module 150 in FIG. 4) and a second magnetic module (e.g., the second magnetic module 160 in FIG. 4) are applied to an electronic device 300 (e.g., a multi-foldable electronic device) that may be folded and unfolded about a plurality of folding axes F1 and F2. Reference number <2001> in FIG. 20 represents a second state (e.g., a fully folded state) of the electronic device 300. Reference number <2002> represents a third state (e.g., a partially folded state) of the electronic device 300. Reference number <2003> represents a first state (e.g., a partially unfolded state) of the electronic device 300.

Referring to FIG. 20, in an embodiment, the electronic device 300 may include a first housing 310 formed to be foldable with respect to a first folding axis F1, a second housing 320, a third housing 330 formed to be foldable with respect to a second folding axis F2, the first magnetic module 150, and the second magnetic module 160. For example, the electronic device 300 may be formed so that the first housing 310 and/or the third housing 330 may be folded or unfolded relative to the second housing 320. The first magnetic module 150 and the second magnetic module 160 may each be disposed in at least one of the plurality of housings 310, 320, and 330 of the electronic device 300. For example, the first magnetic module 150 may be disposed in the third housing 330, and the second magnetic module 160 may be disposed in the second housing 320. The folded state (or folding state) of the electronic device 300 may be maintained by the attractive force acting between the first magnetic module 150 and the second magnetic module 160. By supplying current to a wire (e.g., the wire 154 in FIG. 4) included in the first magnetic module 150, the electronic device 300 may have at least one housing unfolded about a folding axis (e.g., the first folding axis F1 or second folding axis F2). For example, as the attractive force acting between the first magnetic module 150 and the second magnetic module 160 is decreased, the electronic device 300 may be unfolded by a restoring force (e.g., a force to unfold) of a display (e.g., a flexible display) disposed in the plurality of housings 310, 320, and 330. At least one of the first magnetic module 150 or the second magnetic module 160 may include a deformable shape memory alloy member so that the electronic device 300 may be easily unfolded. The first magnetic module 150 and the second magnetic module 160 according to the embodiments disclosed herein may be included in an electronic device (e.g., a laptop computer 1990 in FIG. 21, a foldable type smartphone 1991-2, or a game machine) formed to include at least one hinge to be foldable around the at least one hinge, and may be used for folding and unfolding operations of the electronic device.

FIG. 21 illustrates a block diagram of an exemplary electronic device 2100 capable of performing the operations described herein.

Referring to FIG. 21, the electronic device 2100(e.g., the electronic device 100 of FIG. 1A, or the electronic device 300 of FIG. 20) may be one of various types of electronic devices, such as a notebook computer 2190, smartphones 2191 having various form factors (e.g., a bar-type smartphone 2191-1, a foldable smartphone 2191-2, or a slidable (or rollable) smartphone 2191-3), a tablet PC 2192, a cellular telephone (not shown), and any other similar computing devices (not shown). The components illustrated in FIG. 21, the relationships thereof, and the functions thereof are merely for illustration, and are not intended to limit the implementations described or claimed in the disclosure thereto. The electronic device 2100 may be referred to as a mobile device, a user equipment, a multifunctional device, a portable device, or a server.

The electronic device 2100 may comprise various components including at least one processor 2110 (hereinafter, the processor 2110), at least one memory 2120 (hereinafter, the memory 2120), at least one display 2140 (hereinafter, the display 2140) (e.g., the first display 130 of FIG. 1A, or the second display 131 of FIG. 1B), at least one image sensor 2150 (hereinafter, the image sensor 2150), at least one communication circuitry 2160 (hereinafter, the communication circuitry 2160), and/or at least one sensor 2170 (hereinafter, the sensor 2170) (e.g., the at least one first sensor module 104 of FIG. 1A, or the at least one second sensor module 126 of FIG. 1B). The aforementioned components are merely of an example. For example, the electronic device 2100 may comprise other components (e.g., a power management integrated circuitry (PMIC), an audio processing circuitry, an antenna, a rechargeable battery, or an input/output interface). For example, some components may be omitted from the electronic device (2100). For example, some components may be integrated into one component.

The processor 2110 may be implemented as one or more integrated circuit (or circuitry) (IC) chips and may perform various data processing. The processor 2110 may include at least one electrical circuitry and may process instructions (or program, data, and so on) stored in the memory 2120 individually or collectively in a distributed manner. The processor 2110 may include a processor assembly that includes one or more processing circuitries. The processor may include any processing circuitry that may be operative for controlling operations and performance of one or more components (e.g., the memory 2120, a display 2140, the image sensor 2150, the communication circuitry 2160, and/or the sensor 2170) of the electronic device. For example, the processor 2110 (e.g., an application processor (AP)) may be implemented as a system on chip (SoC) (e.g., one chip or chipset). For example, the processor 2110 may be implemented as a plurality of cores (or at least one core circuitry), a plurality of chips, or a plurality of chipsets. For example, the processor 2110 may comprise one or more processing circuitry. For example, the processor 2110 may comprise one or more processing circuitry which are individually and/or collectively configured to perform various functions of the present disclosure. As a non-limiting example, at least a portion of the processor 2110 may be included in a first chip of the electronic device 2100 and at least another portion of the processor 2110 may be included in a second chip of the electronic device 2100 different from the first chip of the electronic device 2100.

For example, he processor 2110 may comprise a central processing unit (CPU) 2111, a graphics processing unit (GPU) 2112, a neural processing unit (NPU) 2113, an image signal processor (ISP) 2114, a display controller 2115, a memory controller 2116, a storage controller 2117, a communication processor (CP) 2118, and/or a sensor interface 2119. These components of the processor 2110 are merely of an example. For example, the processor 2110 may further comprise other components. For example, some components of the processor 2110 may be omitted from the processor 2110. For example, some components of the processor 2110 may be included as separate components of the electronic device 2100 outside the processor 2110. For example, some components of the processor 2110 (e.g., the memory controller 2116) may be included in other components of the electronic device 2100 (e.g., at least a portion of the memory 2120, an interface (e.g., usable for connecting to at least one component of the electronic device 2100), the display 2140, and/or the image sensor 2150).

The processor 2110 may cause other components of the electronic device 2100 to perform various operations by executing instructions stored in the memory 2120. The CPU 2111 (or a central processing circuitry) may be configured to control the components of the processor 2110 based on execution of instructions stored in the memory 2120 (e.g., the volatile memory 2121 and/or the non-volatile memory 2122). The GPU 2112 (or a graphic processing circuitry) may be configured to execute parallel computations (e.g., rendering). The NPU 2113 (or a neural processing circuitry, or an artificial intelligence (AI) chip) may be configured to execute operations (e.g., convolution computations) for an artificial intelligence model. The ISP 2114 (or an image signal processing circuitry) may be configured to process a raw image obtained from the image sensor 2150 in a format suitable for a component in the electronic device 2100 or a component of the processor 2110. The display controller 2115 (or a display control circuitry, or a display processing unit (DPU)) may be configured to process an image obtained from the CPU 2111, the GPU 2112, the ISP 2114, or the memory 2120 (e.g., the volatile memory 2121) in a format suitable for the display 2140. The memory controller 2116 (or a memory control circuitry) may be configured to control reading data from the volatile memory 2121 and writing data to the volatile memory 2121. The storage controller 2117 (or a storage control circuitry) may be configured to control reading data from the non-volatile memory 2122 and writing data to the non-volatile memory 2122. The CP 2118 (or a communication processing circuitry) may be configured to process data obtained from a component of the processor 2110 in a format suitable for transmission to another electronic device via the communication circuitry 2160, or to process data obtained from another electronic device via the communication circuitry 2160 in a format suitable for processing of the component of the processor 2110. For example, the communication circuitry 2160 may comprise one or more communication circuitry. The sensor interface 2119 (or a sensing data processing circuitry, a sensor hub) may be configured to process data on a state of the electronic device 2100 and/or a state around the electronic device 2100, obtained through the sensor 2170, in a format suitable for a component of the processor 2110.

The memory 2120 may comprise one or more storage mediums (or one or more storage devices). For example, the memory 2120 may include a memory assembly that includes one or more storage mediums. For example, the one or more storage mediums may comprise a permanent memory (e.g., the non-volatile memory 2122) such as a hard drive, a flash memory, a read-only memory (ROM), a semi-permanent memory (e.g., the volatile memory 2121) such as a random access memory (RAM), a storage (or a storage assembly) of any other suitable type, or any combination thereof. The memory 2120 may comprise a cache memory which is a memory of one or more different types used to store data for performing a function or feature of the electronic device 2100 at least temporarily. As a non-limiting example, the cache memory may be included in the processor 2110. The memory 2120 may be fixedly embedded within the electronic device 2100, or may be incorporated onto one or more suitable types of components that may be repeatedly inserted into the electronic device 2100, and removed from the electronic device 2100 (e.g., a subscriber identity module (SIM) card, and/or a secure digital (SD) card).

For example, the memory 2120 may store one or more software applications such as an operating system (or a system) software application, a firmware software application, a driver software application, a plug-in (e.g., add-in, add-on, and/or applet) software application, and/or any other suitable software application. For example, the one or more software applications may include instructions executable by the processor 2110. For example, the memory 2120 may store instructions callable by an application programming interface (API). For example, the memory 2120 may store instructions in a library.

An electronic device according to an embodiment disclosed herein may include a hinge structure (140, 140-1), a first housing (110) connected to the hinge structure (140), a second housing (120) coupled to the hinge structure (140-1) to be foldable with respect to the first housing 110 around the hinge structure (140, 140-1) as a center, a display (130, 131) at least a portion of which is disposed at the first housing (110) and the second housing (120), and a first magnetic module (150) disposed at the first housing (110), and the first magnetic module (150) may include at least one magnetic body (151a, 151b) arranged in a first direction, a first magnetic body housing (151) accommodating the at least one magnetic body (151a, 151b), a wire driving unit (153) at least a portion of which is connected to the first housing (110) and at least partially coupled to the first magnetic body housing (151) so that the first magnetic body housing (151) is movable with respect to the first housing (110), a feeding unit (155) seated on one side of the wire driving unit (153), and a first elastic member (156) with one end in the first direction coupled to the first magnetic body housing (151) and the other end coupled to the wire driving unit (153), and a wire (154) with one end in the first direction coupled to the feeding unit (155) and the other end coupled to the first magnetic body housing (151), the wire (154) may include a shape memory alloy so that a length in the first direction is deformable as current is supplied from the feeding unit (155), the first elastic member (156) may be configured to be deformed in a direction opposite to a deformation direction of the wire (154), and the feeding unit (155) may include a substrate (159) electrically connected to the wire (154) and a second elastic member (158) at least a portion of which is disposed at the substrate (159) and configured to be coupled to the one end of the wire (154) to be deformed in the same direction as the deformation direction of the wire (154).

According to an embodiment disclosed herein, the second elastic member (158) may include a first portion (1581a) that contacts electrodes (1593, 1594) of the substrate (159) and a second portion (1581b, 1581c) that is extended from the first portion 1581a and is coupled to the wire (154).

According to an embodiment disclosed herein, the second portion (1581b, 1581c) may be formed to be extended from one end of the first portion (1581a) in a second direction perpendicular to the first direction, and the wire (154) and the second portion (1581b, 1581c) may be coupled with an adhesive member.

According to an embodiment disclosed herein, an angle formed by the first portion (1581a) and the second portion (1581b, 1581c) may be set to change according to the deformation of the wire (154).

According to an embodiment disclosed herein, in a first state where no current flows through the wire (154), the first portion (1581a) and the second portion (1581b, 1581c) may be formed to form a first angle, and in a second state where current flows through the wire (154), the first portion (1581a) and the second portion (1581b, 1581c) may be deformed to form a second angle.

According to an embodiment disclosed herein, the second angle may be formed to be smaller than the first angle.

According to an embodiment disclosed herein, the second portion (1581b, 1581c) may include a first extension portion (1581b) extended from one end of the first portion (1581a) in a second direction perpendicular to the first direction and a second extension portion (1581c) extended from the other end of the first portion (1581a) in the second direction, and the first extension portion (1581b) and the second extension portion (1581c) may be spaced apart from each other by a specified distance in the first direction.

According to an embodiment disclosed herein, a first recess (1581b_3) through which at least a portion of the wire (154) passes and which is coupled to the wire (154) with an adhesive member may be formed in the first extension portion (1581b), and a second recess (1581c_3) through which at least a portion of the wire (154) passes and which is coupled to the wire (154) with an adhesive member may be formed in the second extension portion (1581c).

According to an embodiment disclosed herein, a first coupling portion (P1) may be formed from the first extension portion 1581b, a portion of the wire (154) that is at least partially surrounded by the first extension portion (1581b), and an adhesive member applied between the first extension portion (1581b) and the portion of the wire (154), and a second coupling portion (P2) may be formed from the second extension portion (1581c), another portion of the wire (154) that is at least partially surrounded by the second extension portion (1581c), and an adhesive member applied between the second extension portion (1581c) and the other portion of the wire (154).

According to an embodiment disclosed herein, the first coupling portion (P1) and the second coupling portion (P2) may be spaced apart from each other by a first distance (D3) in the first direction in a first state where current supply to the wire (154) is cut off, and may be spaced apart from each other by a second distance (D4) smaller than the first distance (D3) in the first direction in a second state where current is supplied to the wire (154) and a length of the wire (154) in the first direction is contracted.

According to an embodiment disclosed herein, the first extension portion (1581b) and the second extension portion (1581c) may be bent at a specified angle with respect to the first portion (1581a) along a contraction direction of the wire (154).

According to an embodiment disclosed herein, the first extension portion (1581b) may be deformed in correspondence with deformation of the wire (154) from the one end of the wire (154) to the first coupling portion (P1), and the second extension portion (1581c) may be deformed in correspondence with deformation of the wire 154 from the other end of the wire (154) to the second coupling portion (P2).

According to an embodiment disclosed herein, the electronic device may further include a second magnetic module (160) disposed inside the second housing (120) and including at least one magnetic body arranged in the first direction, and the second magnetic module (160) may be disposed to be at least partially aligned with the first magnetic module (150) in a state where the second housing (120) is folded with respect to the first housing (110) around the hinge structure (140, 140-1).

According to an embodiment disclosed herein, the first magnetic body housing (151) may be disposed so that an attractive force is acted between the first magnetic module (150) and the second magnetic module (160) in a first state where the wire (154) is not contracted, and may be driven in a direction in which the attractive force between the first magnetic module (150) and the second magnetic module (160) is reduced in a second state where the wire (154) is contracted.

According to an embodiment disclosed herein, the first elastic member (156) may be configured so that the length in the first direction is stretched when a length of the wire (154) in the first direction is contracted.

According to an embodiment disclosed herein, in the state where the length of the wire (154) in the first direction is contracted, an elastic force may be applied to the first magnetic body housing (151) from the first elastic member (156) in a second direction opposite to the first direction, and the length of the wire (154) in the first direction may be relaxed by driving the first magnetic body housing (151) in the second direction by the elastic force.

According to an embodiment disclosed herein, the first magnetic module (150) may further include a fastening member (157) that connects the wire driving unit (153) to the first magnetic body housing (151), an opening (1532, 1534) that accommodates at least a portion of the fastening member 157 may be formed in the wire driving unit 153, and the first magnetic body housing (151) may be moved with respect to the first housing (110) through movement within the opening (1532, 1534) of the fastening member (157).

According to an embodiment disclosed herein, the electronic device may further include a wire housing (152) in which a step (1523) is formed to accommodate at least a portion of the wire (154), and the wire housing (152) may be coupled to the first magnetic body housing (151) so that the other end of the wire (154) is fixable to the first magnetic body housing (151).

According to an embodiment disclosed herein, the wire housing (152) may include an upper plate (1521) coupled to the first magnetic body housing (151) and a lower plate (1522) coupled to the upper plate (1521) and in which the step (1523) is formed, and a heat transfer material may be injected into the step (1523).

A foldable electronic device according to an embodiment disclosed herein may include a hinge structure (140, 140-1), a first housing (110) connected to the hinge structure (140), a second housing (120) coupled to the hinge structure (140) to be foldable with respect to the first housing (110) around the hinge structure (140, 140-1) as a center, a display (130, 131) at least a portion of which is disposed at the first housing (110) and the second housing (120), and a first magnetic module (150) disposed at an inner edge of the first housing (110) located below the display (130, 131), in which the first magnetic module (150) includes at least one magnetic body (151a, 151b) arranged in a first direction, a first magnetic body housing (151) accommodating the at least one magnetic body (151a, 151b), a wire driving unit (153) at least a portion of which is connected to the first housing (110) and at least partially coupled to the first magnetic body housing (151) so that the first magnetic body housing (151) is movable with respect to the first housing (110), a feeding unit (155) seated on one side of the wire driving unit (153), a first elastic member (156) with one end in the first direction coupled to the first magnetic body housing (151) and the other end coupled to the wire driving unit (153), and a wire (154) with one end in the first direction coupled to the feeding unit (155) and the other end coupled to the first magnetic body housing (151), the wire (154) may include a shape memory alloy so that a length in the first direction is deformable as current is supplied from the feeding unit (155), the first elastic member (156) may be configured to be deformed in a direction opposite to a deformation direction of the wire (154), and at least a portion adjacent to the one end of the wire (154) that is coupled to the feeding unit (155) may be formed to be elastically deformed in a direction corresponding to a length change of the wire (154) in the first direction.

What is claimed is:

1. An electronic device comprising:
a hinge structure;
first and second housings foldable about the hinge;
a display at least a portion of which is disposed at the first housing and the second housing; and
a first magnetic module disposed at the first housing,
wherein the first magnetic module includes:
at least one magnetic body arranged in a first direction;
a first magnetic body housing accommodating the at least one magnetic body;
a driver which is connected to the first housing and coupled to the first magnetic body housing so that the first magnetic body housing is movable with respect to the first housing;
a feeder seated on one side of the wire driving unit;
a first elastic member with one end in the first direction coupled to the first magnetic body housing and the other end coupled to the driver; and
a wire with one end in the first direction coupled to the feeder and the other end coupled to the first magnetic body housing,
wherein the wire includes a shape memory alloy so that a length in the first direction is deformable as current is supplied from the feeder,
wherein the first elastic member is configured to be deformed in a direction opposite to a wire deformation direction, and
wherein the feeder includes a substrate electrically connected to the wire and a second elastic member disposed at the substrate and coupled to the one end of the wire to be deformable in the wire deformation direction.

2. The electronic device of claim 1, wherein the second elastic member includes a first portion that contacts an electrode of the substrate and a second portion extended from the first portion and is coupled to the wire.

3. The electronic device of claim 2, wherein the second portion extends from one end of the first portion in a second direction perpendicular to the first direction, and
wherein the wire and the second portion are coupled with an adhesive member.

4. The electronic device of claim 2, wherein an angle formed by the first portion and the second portion is changeable according to wire deformation.

5. The electronic device of claim 4, wherein in a first state where no current flows through the wire, the first portion and the second portion form a first angle, and
wherein in a second state where current flows through the wire, the first portion and the second portion are deformed to form a second angle.

6. The electronic device of claim 5, wherein the second angle is smaller than the first angle.

7. The electronic device of claim 2, wherein the second portion includes a first extension portion extended from one end of the first portion in a second direction perpendicular to the first direction and a second extension portion extended from the other end of the first portion in the second direction, and
wherein the first extension portion and the second extension portion are spaced apart from each other by a specified distance in the first direction.

8. The electronic device of claim 7, wherein a first recess through which the wire passes and which is coupled to the wire with an adhesive member is formed in the first extension portion, and
wherein a second recess through which the wire passes and which is coupled to the wire with an adhesive member is formed in the second extension portion.

9. The electronic device of claim 7, wherein a first coupling portion is formed from the first extension portion, a portion of the wire partially surrounded by the first extension portion, and an adhesive member applied between the first extension portion and the portion of the wire, and
wherein a second coupling portion is formed from the second extension portion, another portion of the wire partially surrounded by the second extension portion, and an adhesive member applied between the second extension portion and the other portion of the wire.

10. The electronic device of claim 9, wherein the first coupling portion and the second coupling portion are spaced apart from each other by a first distance in the first direction in a first state where current supply to the wire is cut off, and are spaced apart from each other by a second distance smaller than the first distance in the first direction in a second state where current is supplied to the wire and a length of the wire in the first direction is contracted.

11. The electronic device of claim 10, wherein the first extension portion and the second extension portion are bent at a specified angle with respect to the first portion along a contraction direction of the wire.

12. The electronic device of claim 9, wherein the first extension portion is deformed in correspondence with deformation of the wire from the one end of the wire to the first coupling portion, and
wherein the second extension portion is deformed in correspondence with deformation of the wire from the other end of the wire to the second coupling portion.

13. The electronic device of claim 1, further comprising a second magnetic module disposed inside the second housing and including at least one magnetic body arranged in the first direction,
wherein the second magnetic module is aligned with the first magnetic module in a state where the second housing is folded with respect to the first housing.

14. The electronic device of claim 13, wherein the first magnetic body housing is disposed such that an attractive force acts between the first magnetic module and the second magnetic module in a first state where the wire is not contracted, and is driven in a direction in which the attractive force between the first magnetic module and the second magnetic module is reduced in a second state where the wire is contracted.

15. The electronic device of claim 1, wherein the first elastic member is configured with a length in the first direction being stretched when a length of the wire in the first direction is contracted.

16. The electronic device of claim 15, wherein in a state where the length of the wire in the first direction is contracted, an elastic force is applied to the first magnetic body housing from the first elastic member in a second direction opposite to the first direction, and the length of the wire in the first direction is relaxed by driving the first magnetic body housing in the second direction by the elastic force.

17. The electronic device of claim 1, wherein the first magnetic module further includes a fastening member that connects the driver to the first magnetic body housing,
wherein an opening that accommodates the fastening member is formed in the driver, and
wherein the first magnetic body housing is moved with respect to the first housing through movement within the opening of the fastening member.

18. The electronic device of claim 1, further comprising a wire housing in which a step is formed to accommodate a portion of the wire,
wherein the wire housing is coupled to the first magnetic body housing so that the other end of the wire is fixable to the first magnetic body housing.

19. The electronic device of claim 18, wherein the wire housing includes an upper plate coupled to the first magnetic body housing and a lower plate coupled to the upper plate and in which the step is formed, and
wherein a heat transfer material is injected into the step.

20. A foldable electronic device comprising:
a hinge structure;
a first housing connected to the hinge structure;
a second housing coupled to the hinge structure to be foldable with respect to the first housing around the hinge structure as a center;
a display at least a portion of which is disposed at the first housing and the second housing; and
a first magnetic module disposed at an inner edge of the first housing located below the display,
wherein the first magnetic module includes:
at least one magnetic body arranged in a first direction;
a first magnetic body housing accommodating the at least one magnetic body;
a driver at least a portion of which is connected to the first housing and at least partially coupled to the first magnetic body housing so that the first magnetic body housing is movable with respect to the first housing;
a feeder seated on one side of the driver;
a first elastic member with one end in the first direction coupled to the first magnetic body housing and the other end coupled to the driver; and
a wire with one end in the first direction coupled to the feeder and the other end coupled to the first magnetic body housing,
wherein the wire includes a shape memory alloy so that a length in the first direction is deformable as current is supplied from the feeder,
wherein the first elastic member is configured to be deformed in a direction opposite to a deformation direction of the wire, and
wherein at least a portion adjacent to the one end of the wire that is coupled to the feeder is formed to be elastically deformed in a direction corresponding to a length change of the wire in the first direction.
